(19) United States
(12) Patent Application Publication
(10) Pub. No.: US 2007/0188303 A1
(43) Pub. Date: Aug. 16, 2007

(54) Method, apparatus and system for controlling access to a storage unit

(76) Inventors: Todd J. Faro, West Covina, CA (US); Charles L. King, Claremont, CA (US)

Correspondence Address: CHALKER FLORES, LLP, 2711 LBJ FRWY, Suite 1036, DALLAS, TX, 75234, US

(21) Appl. No.: 11/317,756

(22) Filed: Dec. 23, 2005

Related U.S. Application Data
(63) Continuation-in-part of application No. 11/042,027, filed on Jan. 25, 2005.
Application No. 11/042,027 is a continuation-in-part of application No. 11/021,285, filed on Dec. 23, 2004.

(51) Int. Cl. B60R 25/00

(52) U.S. Cl. 340/5.73; 340/5.5

(57) ABSTRACT

The present invention provides a system, method and apparatus for controlling access to a storage unit having one or more lockable compartments, at least one locking/unlocking apparatus for the one or more lockable compartments, a unit controller and a power supply electrically connected to the at least one locking/unlocking apparatus and the unit controller. The unit controller is communicably coupled to the locking/unlocking apparatus and receives a message from a remote controller and controls the locking/unlocking apparatus based on the message. The modular storage unit may include an overhead storage unit, a storage pedestal, a storage cabinet, a lateral storage unit, a file cabinet or a desk drawer. The remote controller may include a user device, network device that stores one or more security profiles containing user access data for one or more authorized users, one or more trigger event/action protocols, other access activity information or a combination thereof.

### PRIORITY CLAIM

This patent application is a continuation-in-part of U.S. patent application Ser. No. 11/042,027 filed on Jan. 25, 2005, which is a continuation-in-part of U.S. patent application Ser. No. 11/021,285 filed on Dec. 23, 2004, both of which are hereby incorporated by reference in its entirety.

### TECHNICAL FIELD OF THE INVENTION

The present invention relates, in general, to the field of security, and in particular, to a method, apparatus and system for controlling access to a storage unit.

### BACKGROUND OF THE INVENTION

Without limiting the scope of the invention, the background of the invention is described in connection with controlling access to file cabinets, as an example. Controlling access to the contents of file cabinets, such as documents, valuables, expensive equipment and other important information or items, has always been important. As a result, one or more keyed locks mounted on the cabinet are used to control access to the contents of cabinet. If more security is needed, the cabinets are typically placed in a secured room to which only authorized personnel had access. The security of the room containing the cabinets and consequently the complexity of the security system used to obtain access to the room vary greatly depending on the application. Regardless of the situation, it has long been believed that the cabinets were merely simple fungible storage units and that any additional security for the cabinets should be designed into the building security in which the cabinets were stored.

For example, one of the most common cabinet locking mechanisms is a keyed lock mounted on the cabinet that operates an internal lever or slide bar that prevents the compartments of the cabinet from being opened when the cabinet is locked. Another example is an external swing-open security bar that locks every drawer. The bar is mounted to the exterior of the file cabinet and partially over the drawers and includes a keyed lock. When the lock is removed, the bar may be moved or removed to allow the drawers to be opened. The system may have individual bars and locks for each drawer or one lock and bar for multiple drawers.

Conventional methods rely on keys or secret passwords to restrict access to filed information. Keys and/or passwords are issued to individuals that are allowed access to the files and require the individual to safeguard the key or password. These systems rely on the assumption that the person possessing the key or knowing the password has proven his or her identity, assuming that this has authenticated the authorized user. However, this is not always the case. There are instances where the key or password is intentionally passed to a third person or unintentionally and illegally acquired or duplicated by a third person.

Additionally, it is possible that each file cabinet may need a different key or password. Therefore, another drawback is the shear number of keys or passwords an individual must keep track of and secure. Similarly, different individuals may have different levels of access to files requiring different keys and passwords, different storage procedures, all of which increase the cost and complexity of the system.

Despite these shortcomings, the key and password methods are among the most common file cabinet security methods used. Although alternative identification methods, such as biometric identification (e.g., fingerprints, etc.), are sometimes used for building security, they have been considered too expensive or impractical for standard cabinets. For example, a business may have tens to hundreds to thousands of file cabinets in use, depending on the type of business and the number of files being stored. As a result, it has not been practical, if it has even been considered, to increase the security of the individual cabinets. If added security was needed, the cabinets were placed in a more secure location within a building.

With the advent of more stringent security requirements for business and personal information due to industrial espionage, national security and HIPPA requirements, many individuals and businesses have had to reassess their security measures to safeguard and document access to such information. For example, an unlocked file cabinet containing medical records, business information or personal information is not very effective at limiting who can open a drawer and look at the records. Furthermore, when cabinets are locked with a conventional lock, there is no assurance that the person opening the lock is the authorized person or that that person is entitled to open that specific portion of the cabinet. Yet in many of these cases, retrofitting an office or upgrading a security system to protect standard cabinets that must be routinely accessed during business hours is either too costly or not possible.

As a result, there is a need for a system, method and apparatus for controlling access to a storage unit by using equipment that can be easily and inexpensively installed on an existing storage unit.

### SUMMARY OF THE INVENTION

The present invention provides a system, method and apparatus for controlling access to a storage unit (e.g., cabinet, modular storage unit, etc.) by using equipment that can be easily and inexpensively installed on an existing storage unit. As a result, existing unsecured storage units can be retrofitted with security equipment to control access to all or part of the contents of the storage unit without having to install or upgrade expensive or complex building security systems. The present invention provides more precise control over access to storage units, while increasing the security through a more rigorous user authentication process and recordation of who accessed the storage unit and when the access occurred. The present invention can be incorporated into the construction of new storage units or provided as a kit to retrofit existing storage units. The complexity of the retrofit system will depend on the level of security that is needed for the particular application and the specific security measures that are already in place, if any. In addition, the present invention can be used to save space and consolidate filing storage units by allocating specific compartments to individuals instead of storage units. For example, two employees may each require a lockable compartment, so two lockable storage units have to be provided using current equipment. The controlled access to individual compartments of a storage unit as provided by the present invention can eliminate the need for one of the lockable storage units. As a result, the present invention is adaptable and scalable to any security application.

For example, a storage unit equipped with the present invention can provide dual custody security, allow compartments to be opened one at a time or all at once, either locally or from a remote location, provide variable security scenarios based on date, time, business hours, holidays, etc., automatic locking/unlocking according to a schedule, alarms or compartment closure, and provide audit trails detailing access and attempted access to the compartments. Access to the storage unit can be determined using user access data, such as personal identification numbers, passwords, fingerprints, hand prints, voice prints, iris scans, retina scans, facial scans, wireless signals or any combination thereof. This user access data can be input or read using various types of user interfaces, such as biometric sensors, card readers, keypads, touch screens, scanners, wireless receivers, wiegand readers or any combination thereof. Moreover, the present invention can be equipped with various sensors and alarms based on heat, smoke, position, weight, loss of power, low battery, vibration, forced entry, “open to long”, etc. The storage units can function as stand alone security units and/or be integrated into a building security system.

More specifically, the present invention provides a modular storage unit having one or more lockable compartments, at least one locking/unlocking apparatus for the one or more lockable compartments, a unit controller and a power supply electrically connected to the at least one locking/unlocking apparatus and the unit controller. The unit controller is communicably coupled to the locking/unlocking apparatus and receives a message from a remote controller and controls the locking/unlocking apparatus based on the message. The modular storage unit may include an overhead storage unit, a storage pedestal, a storage cabinet, a lateral storage unit, a file cabinet or a desk drawer. The one or more lockable compartments may include a door or a drawer. The remote controller may include a user device (e.g., computer, personal data assistant (“PDA”), phone, handheld computer, radio frequency identification device (“RFID”), etc.), network device (e.g., network node, network controller, a server, etc.) that stores one or more security profiles containing user access data for one or more authorized users, one or more trigger event/action protocols, other access activity information or a combination thereof. The user access data may include a personal identification number, a password, a fingerprint, a hand print, a voice print, an iris scan, a retina scan, a facial scan, a wireless signal, a user device status or a combination thereof. The other access activity information may include a date, an attempted access time, an unlock time, a lock time, a result of the comparison of the received user access data with the user access data for the one or more authorized users, a status of the locking/unlocking apparatus or a combination thereof. The unit controller may receive the message via a network cable, USB type cable or wireless communication link. The power supply may include an AC-DC converter, one or more batteries, a USB type connection or a combination thereof.

In addition, the present invention provides a system for controlling access to one or more modular storage units within a modular workstation. The system includes the one or more modular storage units, a communications network and a remote controller. Each modular storage unit includes one or more lockable compartments, at least one locking/unlocking apparatus for the one or more lockable compartments, and a unit controller communicably coupled to the locking/unlocking apparatus that receives a message from the remote controller and controls the locking/unlocking apparatus based on the message. The communications network (e.g., one or more communication cables, a wired network, a wireless network or combination thereof) communicably couples the remote controller to the unit controller of each modular storage unit.

The present invention also provides an apparatus for controlling access to a modular storage unit having one or more lockable compartments and at least one locking/unlocking apparatus. The apparatus includes a unit controller that receives a message from a remote controller and controls the locking/unlocking apparatus based on the message.

Moreover, the present invention provides a method for controlling access to a modular storage unit having one or more lockable compartments, at least one locking/unlocking apparatus and a unit controller. The method includes receiving a message from a remote controller via the unit controller, and controlling at least one of the lockable compartments based on the received message. Note that the methods described herein can be implemented as a computer program embodied on a computer readable medium wherein one or more code segments perform one or more steps.

In addition, the present invention provides a kit for retrofitting a modular workstation having one or more modular storage units with one or more compartments to a controlled access modular workstation having one or more lockable compartments. The kit includes at least one locking/unlocking apparatus, a unit controller and a computer program. Each locking/unlocking apparatus is suitable for mounting within each modular storage unit to convert the one or more compartments to one or more lockable compartments. The unit controller is suitable for mounting on or within each modular storage unit to control the at least one locking/unlocking apparatus based on a message received from a remote controller. The computer program is for the remote controller to determine whether or not to send the message to the unit controller. The message includes an instruction to lock or unlock one or more of the lockable compartments or information that can be used to determine whether to lock or unlock one or more of the lockable compartments.

The present invention also provides a method for retrofitting a modular workstation having one or more modular storage units with one or more compartments to a controlled access modular workstation having one or more lockable compartments. The method includes installing at least one locking/unlocking apparatus within each modular storage unit to convert the one or more compartments to one or more lockable compartments, installing a unit controller on or within each modular storage unit, connecting the unit controller to the at least one locking/unlocking apparatus such that the unit controller controls the operation of the at least one locking/unlocking apparatus in response to a message from a remote controller, installing a computer program on the remote controller to determine whether or not to send the message to the unit controller. The message includes an instruction to lock or unlock one or more of the lockable compartments or information that can be used to determine whether to lock or unlock one or more of the lockable compartments.

The present invention is described in detail below with reference to the accompanying drawings.

### BRIEF DESCRIPTION OF THE DRAWINGS

For a more complete understanding of the features and advantages of the present invention, reference is now made to the detailed description of the invention along with the accompanying figures and in which:

FIG. 1A is a perspective view of a file cabinet in accordance with one embodiment of the present invention;

FIG. 1B is a perspective view of the file cabinet of FIG. 1A in which the internal equipment installed in the cabinet is shown in accordance with one embodiment of the present invention;

FIG. 2 is a block diagram of a cabinet in accordance with one embodiment of the present invention;

FIG. 3 is a side view of a locking/unlocking apparatus in accordance with one embodiment of the present invention;

FIG. 4 is a flow chart illustrating a method of controlling access to a cabinet in accordance with one embodiment of the present invention;

FIG. 5 is a block diagram of a system of controlling access to multiple cabinets in accordance with one embodiment of the present invention;

FIG. 6 is a block diagram of a cabinet in accordance with another embodiment of the present invention;

FIGS. 7A, 7B, 7C and 7D are flowcharts illustrating a method of controlling access to a cabinet in accordance with another embodiment of the present invention;

FIG. 8 is a perspective view of a file cabinet in which the internal equipment installed in the cabinet is shown in accordance with one embodiment of the present invention;

FIG. 9 is a block diagram of a cabinet in accordance with one embodiment of the present invention;

FIG. 10 is a flow chart illustrating a method of controlling access to a cabinet in accordance with one embodiment of the present invention;

FIG. 11 is a perspective view of a file cabinet in which the internal equipment installed in the cabinet is shown in accordance with one embodiment of the present invention;

FIG. 12 is a block diagram of a cabinet in accordance with one embodiment of the present invention;

FIG. 13 is an isometric view of controlled access cabinet in accordance with one embodiment of the present invention;

FIG. 14 is an isometric view of controlled access cabinet in accordance with another embodiment of the present invention;

FIG. 15 is a block diagram of a modular workstation in accordance with one embodiment of the present invention;

FIG. 16 is a block diagram of a unit controller within a modular storage unit in accordance with one embodiment of the present invention;

FIG. 17 is a flow chart illustrating a method of controlling access to a modular storage unit in accordance with one embodiment of the present invention;

FIGS. 18, 19 and 20 are isometric views of modular workstations in accordance with various embodiments of the present invention;

FIG. 21 is a block diagram of a system for controlling access to one or more modular storage units within a modular workstation in accordance with one embodiment of the present invention;

FIG. 22 is a block diagram of a system for controlling access to one or more modular storage units within a modular workstation in accordance with another embodiment of the present invention;

FIG. 23 is a block diagram of a system for controlling access to one or more modular storage units within a modular workstation in accordance with yet another embodiment of the present invention;

FIG. 24 is a block diagram of a system for controlling access to one or more modular storage units within two groups of modular workstations in accordance with yet another embodiment of the present invention; and

FIG. 25 is a flow chart illustrating a method of controlling access to a modular storage unit in accordance with one embodiment of the present invention.

### DETAILED DESCRIPTION OF THE INVENTION

While the making and using of various embodiments of the present invention are discussed in detail below with respect to a file cabinet, it should be appreciated that the present invention provides many applicable inventive concepts that can be embodied in a wide variety of specific contexts, including but not limited to, office furniture or any type of storage units having drawers or doors. As a result, the terminology used and specific embodiments discussed herein are merely illustrative of specific ways to make and use the invention and do not delimit the scope of the invention.

The present invention provides a system, method and apparatus for controlling access to a storage unit (e.g., cabinet, modular storage unit, etc.) by using equipment that can be easily and inexpensively installed on an existing storage unit. As a result, existing unsecured storage units can be retrofitted with security equipment to control access to all or part of the contents of the storage unit without having to install or upgrade expensive or complex building security systems. The present invention provides more precise control over access to storage units, while increasing the security through a more rigorous user authentication process and recordation of who accessed the storage unit and when the access occurred. The present invention can be incorporated into the construction of new storage units or provided as a kit to retrofit existing storage units. The complexity of the retrofit system will depend on the level of security that is needed for the particular application and the specific security measures that are already in place, if any. In addition, the present invention can be used to save space and consolidate filing storage units by allocating specific compartments to individuals instead of storage units. For example, two employees may each require a lockable compartment, so two lockable storage units have to be provided using current equipment. The controlled access to individual compartments of a storage unit as provided by the present invention can eliminate the need for one of the lockable storage units. As a result, the present invention is adaptable and scalable to any security application.

For example, a storage unit equipped with the present invention can provide dual custody security, allow compartments to be opened one at a time or all at once, either locally or from a remote location, provide variable security scenarios based on date, time, business hours, holidays, etc., automatic locking/unlocking according to a schedule, alarms or compartment closure, and provide audit trails detailing access and attempted access to the compartments. Access to the storage unit can be determined using user access data, such as personal identification numbers, passwords, fingerprints, hand prints, voice prints, iris scans, retina scans, facial scans, wireless signals or any combination thereof. This user access data can be input or read using various types of user interfaces, such as biometric sensors, card readers, keypads, touch screens, scanners, wireless receivers, wiegand readers or any combination thereof. Moreover, the present invention can be equipped with various sensors and alarms based on heat, smoke, position, weight, loss of power, low battery, vibration, forced entry, “open to long”, etc. The storage units can function as stand alone security units and/or be integrated into a building security system.

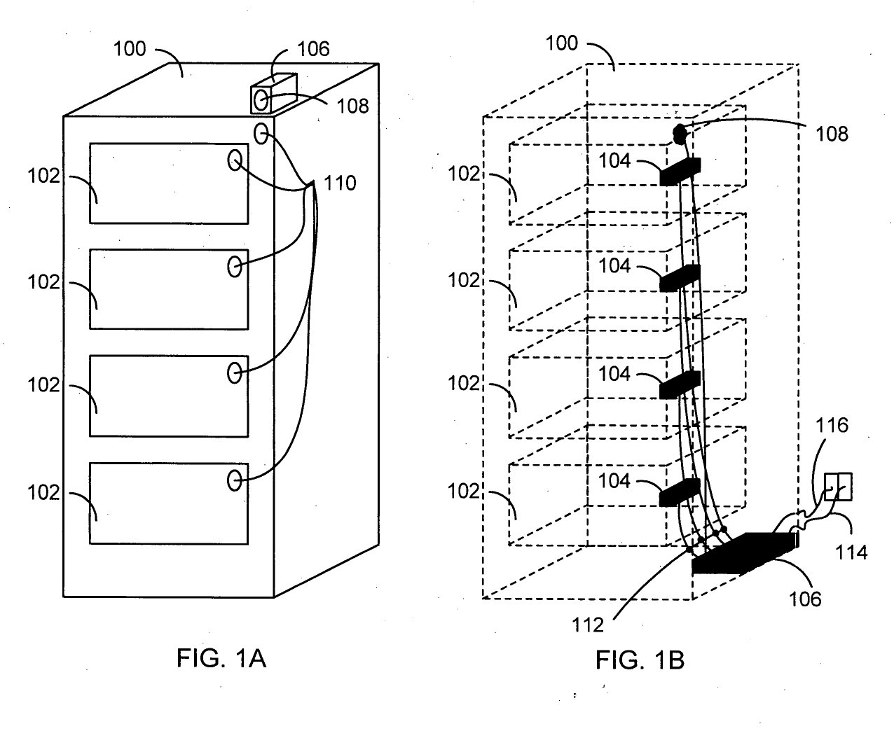

Now referring to FIGS. 1A and 1B, perspective views of a cabinet 100 in accordance with one embodiment of the present invention are shown. The present invention provides a cabinet 100 that includes one or more lockable compartments 102, at least one locking/unlocking apparatus 104 for the one or more lockable compartments 102, a user access device 106 communicably coupled to the locking/unlocking apparatus 104 and a power supply (not shown in FIG. 1A; integrated into user access device 106 in FIG. 1B) electrically connected to the at least one locking/unlocking apparatus 104 and the user access device 106. As used herein, a cabinet 100 may include a file cabinet, a storage cabinet, a portion of a desk or any other type of office/industrial furniture that contains compartments (drawers or doors). Moreover, the cabinet 100 may be of different sizes to accommodate the different needs of the business or hospital, e.g., files, documents, receipts, samples, supplies, medicines, tools and the like. Additionally, the one or more lockable compartments 102 may be of different sizes as well. Furthermore, the size of the one or more lockable compartments 102 may vary in a cabinet 100, for example, having one or more larger lockable compartments 102 at the bottom and one or more smaller lockable compartments 102 at the top. The lockable compartments 102 can be individually lockable or all locked with a single mechanism. Likewise, various components can be communicably coupled together using simple wires, communication cables, circuit board interconnects and traces, optical cables, wireless connections or any other means that allow one device to communicate with or control another device.

The locking/unlocking apparatus 104 can be any electrically operated locking mechanism, such as a solenoid driven latch, plunger or rod, an electromagnetic latch, or any other controllable locking/unlocking means. The locking/unlocking apparatus 104 can be installed in any practical location within the cabinet 100 (e.g., at the back, side, front, top or bottom of the compartment 102). Moreover, the number of locking/unlocking apparatuses 104 used will depend on the application and range from a single locking/unlocking apparatus 104 to secure all the compartments 102 in the cabinet 100 to one locking/unlocking apparatus 104 to secure each compartment 102 in the cabinet 100. Typically, the locking/unlocking apparatus 104 is selected to automatically lock when the corresponding lockable compartment 102 is closed and to remain in a normally locked position without power, which prevents access by simply interrupting the power to the cabinet 100. As shown in FIG. 1B, each locking/unlocking apparatus 104 can be communicably connected to the user access device by individual wires 112 (e.g, 18/2). The communication can be as simple as applying voltage to a relay or solenoid, or a complex as a coded or multiplexed wireless transmission to a receiver installed on the locking/unlocking apparatus 104. For example, each locking/unlocking apparatus 104 can have a separate communication channel.

The control portion of the user access device 106 is typically located internally to the cabinet 100 as shown in FIG. 1B. The location within the cabinet 100 may be varied depending on the space available and the level of security needed. The control portion of the user access device 106 may be positioned on the underside of the cabinet 100 or on the back wall of the cabinet 100. Furthermore, a specific housing may be constructed within the cabinet 100 to accommodate the control unit. The housing may be engineered to prevent access to the control unit. The user access device 106 includes a user interface 108, a data storage device (integrated into user access device 106) and a processor (integrated into user access device 106). The components of the user access device 106 can be integrated into a single unit or distributed within or on the cabinet 100. The user interface 108 receives the user access data from a user attempting to access the cabinet 100. Each cabinet 100 can be equipped with one or more user interfaces 108. For example, a keyed lock or user interface 108 can be installed at positions 110 in FIG. 1 A. Moreover, a single user interface 108 can be used to gain access to only a single lockable compartment 102 based on a security level associated with the user or inputs provided at the time of the access request (e.g., keypad, selection buttons, touch screen, voice command, etc.). The user interface 108 may include a biometric sensor, a card reader, a keypad, a touch screen, a scanner, a wireless receiver, a wiegand reader or any combination thereof. Likewise, the user access data may include a personal identification number, a password, a fingerprint, a hand print, a voice print, an iris scan, a retina scan, a facial scan, a wireless signal or any combination thereof.

The data storage device stores the received user access data, other access activity information and the user access data for one or more authorized users. The data storage device may include a memory, a hard drive, a disk drive, a database or any combination thereof. The other access activity information may include a date, an attempted access time, an unlock time, a lock time, a result of the comparison of the received user access data with the user access data for the one or more authorized users, a status of the locking/unlocking apparatus or a combination thereof. The processor compares the received user access data with the user access data for the one or more authorized users and controls the locking/unlocking apparatus 104 based on the comparison. The processor can also determine which of the one or more lockable compartments 104 to unlock based on a security level associated with the user access data for the one or more authorized users. In addition, the processor can communicate with a building or central security center via a standard local area network connection 114. The processor can also be connected to one or more sensors, such as a heat sensor, a smoke sensor, a lockable compartment position sensor, a weight sensor, a loss of power sensor, a low battery sensor, a vibration sensor, a forced entry sensor, an “open to long” sensor or any combination thereof.

The power supply may include an AC-DC converter, one or more batteries or any combination thereof. In addition, the power supply may include a power management device (integrated into user access device 106) electrically connected to the user access device 106 and the locking/unlocking apparatus 104, a primary power supply electrically connected to the power management device and a secondary power supply electrically connected to the power management device. The primary power supply is connected to an external power source 116, such as a building AC outlet. The secondary power supply typically comprises one or more batteries. Often such batteries will provide backup power to the system for four to six hours and are recharged when primary power is restored.

Additionally, a screen, monitor, touch screen, keyboard or keypad (not shown) may be in connected to the cabinet 100 to display information, warnings, procedures, identities, time, date or allow input for a user. The cabinet 100, therefore, can be equipped with numerous accessories, such as a wireless interface communicably coupled to the user access device 106, a network interface communicably coupled to the user access device 106, an input/output interface communicably coupled to the user access device 106, one or more sensors communicably coupled to the user access device 106, one or more alarms communicably coupled to the user access device 106, a timer communicably coupled to the user access device 106, or a power management device electrically connected to the power supply and one or more batteries.

Note that the user access data may be stored a token (e.g., card, badge, key, disk, hard drive, jump drive or other object capable of storing information) carried by the user or located on or about the cabinet 100. For example, access to a cabinet 100 may require a biometric user access data from the user access device 108 (e.g., a fingerprint scan) and insert an encoded security card into a card reader. When biometric user access data is used, the level of security of the cabinet may be varied by adjusting the stringency of the match between the biometric user access data and the stored biometric access data. In addition, redundant systems may be used which would include two or more authentication comparisons. For example, the individual may be required to input a password and submit a fingerprint scan, submit a fingerprint scan and a retinal scan or require two or more individuals to submit fingerprint scans before access is granted. The redundant authentication will allow even a greater level of security.

Furthermore, the present invention provides a kit for retrofitting a cabinet having one or more compartments to a controlled access cabinet 100 having one or more lockable compartments 102. The kit includes at least one locking/unlocking apparatus 104 suitable for mounting within the cabinet 100 to convert the one or more compartments to one or more lockable compartments 102 and a user access device 106 suitable for mounting on or within the cabinet 100 to control the at least one locking/unlocking apparatus 104. The user access device 106 includes a user interface 108, a data storage device and a processor. The user interface 108 receives user access data. The data storage device stores the received user access data, other access activity information and user access data for one or more authorized users. The processor compares the received user access data with the user access data for the one or more authorized users and controls the locking/unlocking apparatus 104 based on the comparison.

Similarly, the present invention provides a method for retrofitting a cabinet having one or more compartments to a controlled access cabinet 100 having one or more lockable compartments 102. At least one locking/unlocking apparatus 104 is installed within the cabinet 100 to convert the one or more compartments to one or more lockable compartments 102. A user access device 106 is also installed on or within the cabinet 100. The user access device 106 is then connected to the at least one locking/unlocking apparatus 104 such that the user access device controls the operation of the at least one locking/unlocking apparatus 104. The user access device 106 includes a user interface, a data storage device and a processor. The user device receives user access data. The data storage device stores the received user access data, other access activity information and user access data for one or more authorized users. The processor compares the received user access data with the user access data for the one or more authorized users and controls the locking/unlocking apparatus 104 based on the comparison.

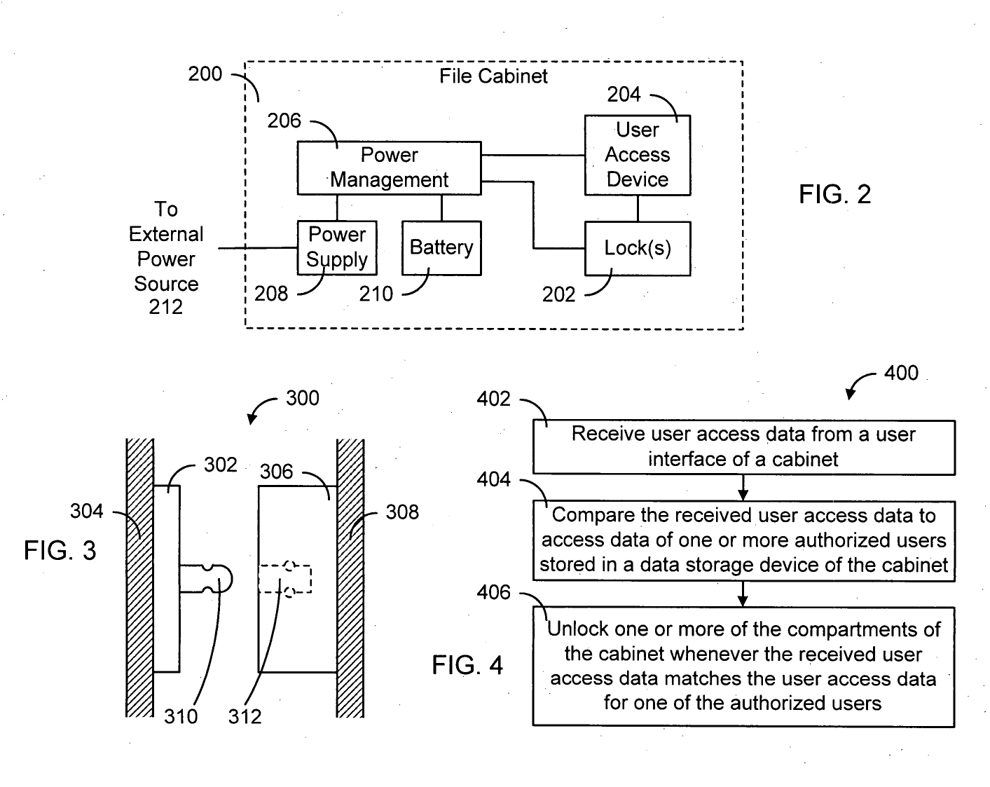

Referring now to FIG. 2, a block diagram of a cabinet 200 in accordance with one embodiment of the present invention is shown. The cabinet 200 includes an apparatus that controls access to the cabinet 200 having one or more lockable compartments and at least one locking/unlocking apparatus 202. The apparatus includes a user access device 204 that is communicably coupled to the at least one locking/unlocking apparatus 202 and includes one or more user interfaces, a data storage device and a processor. The one or more user interfaces receive user access data. The data storage device stores the received user access data, other access activity information and user access data for one or more authorized users. The processor compares the received user access data with the user access data for the one or more authorized users and controls the locking/unlocking apparatus 202 based on the comparison. This particular embodiment also includes a power management device 206 electrically connected to the at least one locking/unlocking apparatus 2002, the user access device 204, a power supply 208 and one or more batteries 210. The power supply 208 is then electrically connected to an external power source 212.

Now referring to FIG. 3, a side view of a locking/unlocking apparatus 300 in accordance with one embodiment of the present invention is shown. The locking/unlocking apparatus 300 includes a first section 302 attached to the back of a lockable compartment 304 and a second section 306 attached to the inside back portion of the cabinet 308. The two section 302 and 306 are aligned such that a locking pin 310 attached to the first section 302 is inserted into a pin receiving mechanism 312 in the second section 306. The pin receiving mechanism 312 securely holds the locking pin 310 in place until the user access device signals the locking/unlocking apparatus 300 to change to an unlocked status. As previously discussed, this is only one type of locking/unlocking apparatus and does not limit the scope of the invention in that any type or configuration of locking/unlocking apparatus can be used with the present invention. For example, each locking mechanism may include a solenoid attached to the cabinet wherein the solenoid extends an extendable member that contacts a receiving mechanism attached to the one or more lockable compartments. Likewise, each locking mechanism may include a motor attached to the cabinet wherein the motor extends an extendable member that contacts a receiving mechanism attached to the one or more lockable compartments.

Referring now to FIG. 4, a flow chart illustrating a method 400 of controlling access to a cabinet in accordance with one embodiment of the present invention is shown. As previously discussed, the cabinet has one or more lockable compartments, at least one locking/unlocking apparatus, one or more user interfaces, a data storage device and a processor. First, user access data is received from one of the user interfaces of the cabinet in block 402. The received user access data is then compared with user access data for one or more authorized users stored in the data storage device of the cabinet in block 404. At least one of the lockable compartments of the cabinet is unlocked whenever the received user access data matches the user access data for one of the authorized users in block 406. The received user access data and other access activity information are also stored in the data storage device. This method can be implemented as a computer program embodied on a computer readable medium wherein each step comprised one or more code segments.

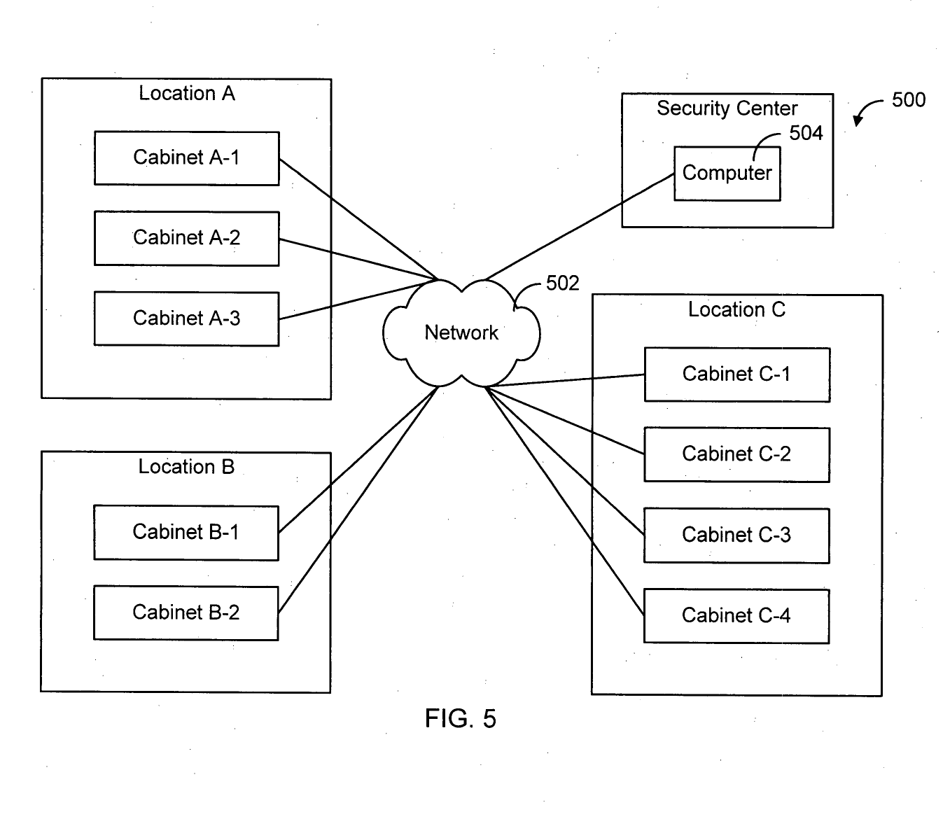

Now referring to FIG. 5, a block diagram of a system 500 of controlling access to multiple cabinets in accordance with one embodiment of the present invention is shown. The system includes a network 502, a computer 504 communicably coupled to the network 502 and two or more cabinets (any two cabinets selected from A-1, A-2, A-3, B-1, B-2, C-1, C-2, C-3, C-4). Each cabinet (A-1, A-2, A-3, B-1, B-2, C-1, C-2, C-3, C-4) includes one or more lockable compartments, at least one locking/unlocking apparatus for the one or more lockable compartments, and a user access device communicably coupled to the network 502 and the locking/unlocking apparatus. The user access device includes a user interface, a data storage device and a processor. The user interface receives the user access data. The data storage device stores the received user access data, other access activity information and user access data for one or more authorized users. The processor compares the received user access data with the user access data for the one or more authorized users and controls the locking/unlocking apparatus based on the comparison.

As shown, Location A includes Cabinet A-1, Cabinet A-2 and Cabinet A-3; Location B includes Cabinet B-1 and Cabinet B-2; and Location C includes Cabinet C-1, Cabinet C-2, Cabinet C-3 and Cabinet C-4. Locations A, B and C can be located locally (within the same building) or remotely to one another and to the Security Center. The computer 504 in the Security Center can be used to monitor and/or control the Cabinets connected to the network 502. For example, the computer 504 can monitor the status of sensors and alarms in the Cabinets, maintain a second access log, and provide redundant user access data verification. In such a case, the processor within the Cabinets will send the received user access data to the computer 504 via the network 502 and the computer 504 will compare the received user access data with the user access data for the one or more authorized users. The computer 504 can take active (log the information, deny access and alert the Security Center) or passive action (log the information and alert the Security Center) based on the comparison.

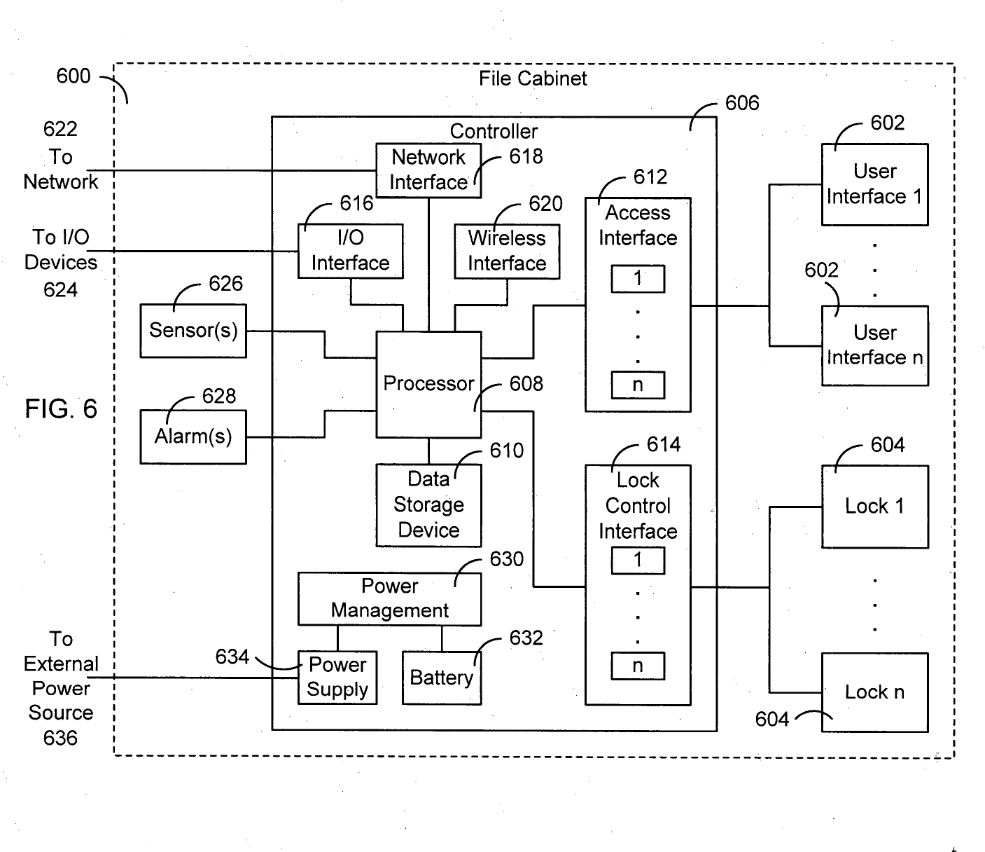

Referring now to FIG. 6, a block diagram of a cabinet 600 in accordance with another embodiment of the present invention is shown. The cabinet 600 includes one or more user interfaces 602, one or more locking/unlocking apparatuses 604 and a controller 606 communicably coupled to the one or more user interfaces 602 and one or more locking/unlocking apparatuses 604. The controller 606 includes a processor 608, a data storage device 610, an access interface 612 and a lock control interface 614. The access interface 612 allows the multiple user interfaces 602 to communicate with and be controlled by the processor 608. Similarly, the lock control interface 614 allows the processor 608 to control multiple locking/unlocking apparatuses 604. The controller 606 may also include one or more other interfaces (input/output interface 616, network interface 618, wireless interface 620) communicably coupling the processor 608 to various external devices (e.g., network 622 and input/output devices 624). The processor 606 may also be communicably coupled with one or more sensors 626 and one or more alarms 628. The controller 606 is powered by a power management device 630 electrically connected to one or more batteries 632 and a power supply 634. The power supply 634 is electrically connected to an external power source 636. Note that the various types of user interfaces 602, locking/unlocking apparatuses 604, data storage devices 610, sensors 626, alarms 629, batteries 632 and power supplies 634 that can be used with the present invention have been previously described.

With respect to the use of alarms 628, the present invention can activate the alarm 628 in response to a variety of circumstances, e.g., an attempt at unauthorized entry, the cabinet 600 remaining unlocked or open for an extended period of time, one or more compartments remaining open for an extended period of time, the incorrect match of user access data, an attempt to move the cabinet 600, the tilting of the cabinet 600, the moving of the cabinet 600, the interruption of power to the cabinet 600 or force one or more drawers to open. The alarm 628 may be internally mounted, externally mounted, attached to a network or combinations thereof. Furthermore, the alarm may be in the form of a display, a light, a silent alarm, a siren, a buzzer, a noise, the activation of a video camera, the activation of an audio recorder, a signal to a remote location or combinations thereof. The alarm 628 further heightens security through alerting others to unauthorized activities.

The present invention can also include a recording mechanism that records information relating to the access of the cabinet 600. The recording mechanism may record a video image, a photograph, an audio track, a time, a date, a duration of access, the number of times an individual access a cabinet 600, the number of times a cabinet 600 has been accessed or combinations thereof. The recording feature may be particularly useful in performing audits. Furthermore, the controller 606 may perform routines designating particular protocols for specific scenarios. For example, the controller 606 may lock and unlock all of the one or more compartments at a particular time (e.g., in the case of normal operating hours) or the controller 606 may lock the compartments for a given period of time (e.g., holidays). The controller 606 may record the number of accesses and limit that to a specified number of times. The controller 606 may also have a time and date stamp associated with each unlocking sequence.

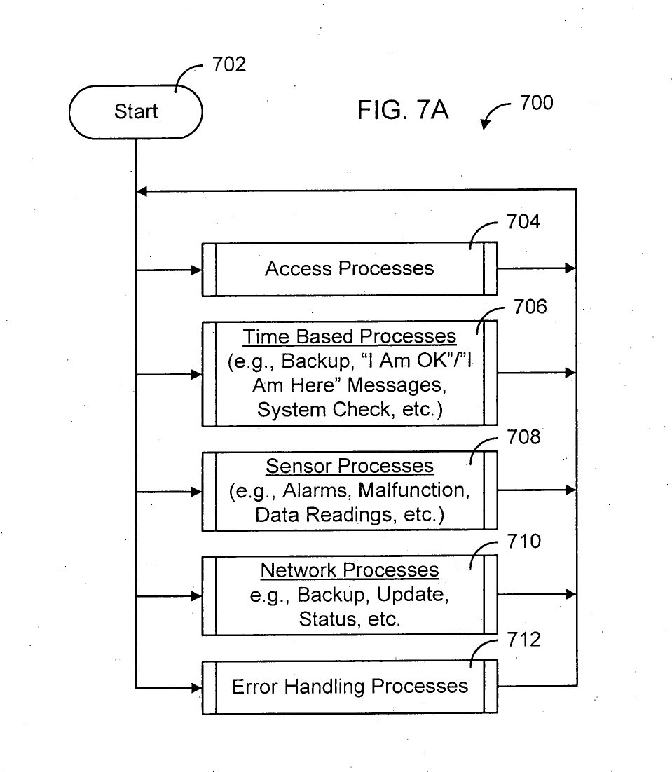

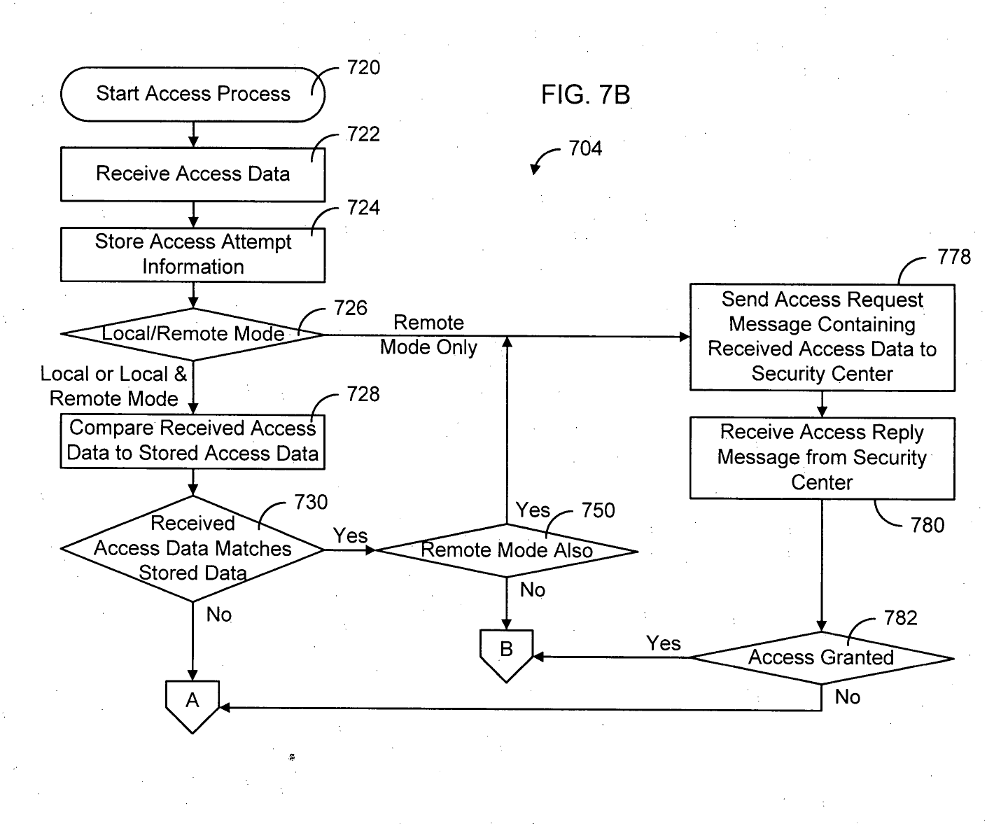

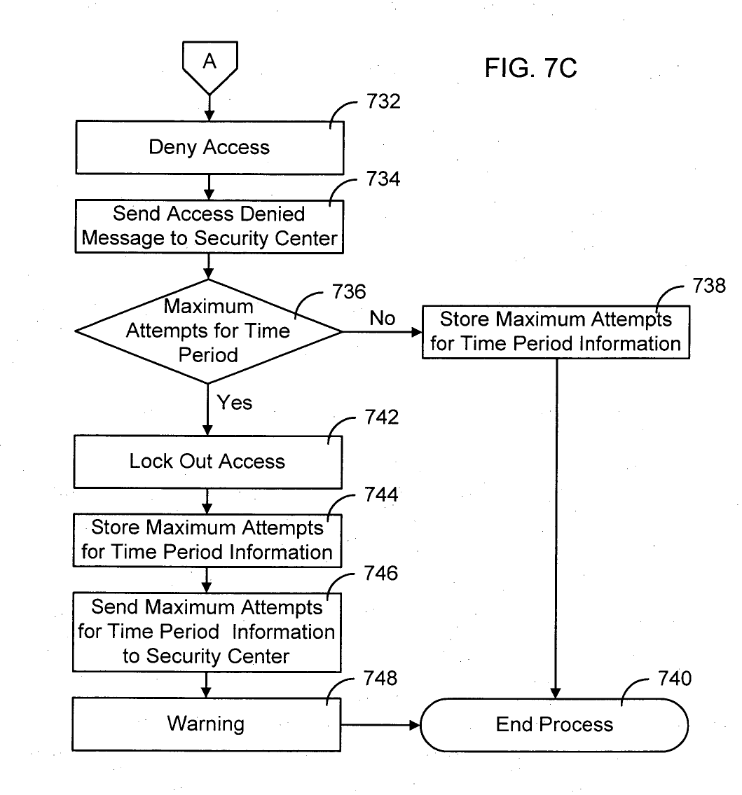

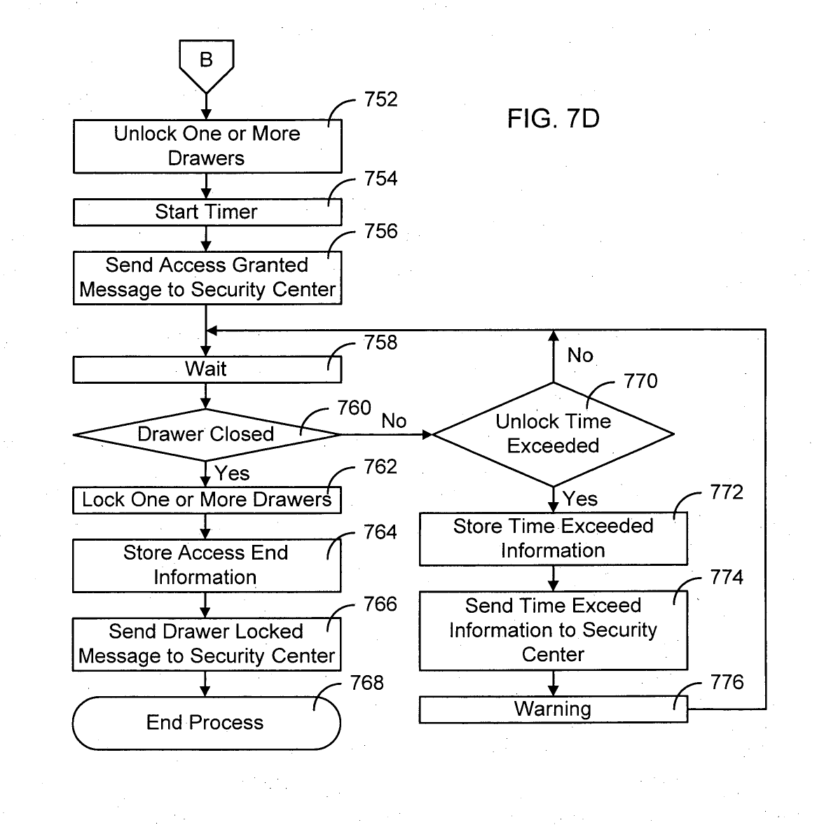

Now referring to FIGS. 7A, 7B, 7C and 7D, flowcharts illustrating a method 700 of controlling access to a cabinet in accordance with another embodiment of the present invention are shown. The process 700 starts in block 702 and performs various processes as necessary based on various operating parameters and inputs. The processes may include access processes 704, time based processes 706, sensor processes 708, network processes 710 and error handling processes 712. One such access process 702 will be described in more detail in reference to FIGS. 7B, 7C and 7D. The other processes will vary depending on the application. The time based processes 706 may include scheduled data backups, “I AM OK” or “I AM NOT OK” messages that respond to query messages from a security center computer via a network, periodic “I AM HERE” messages sent to the security center computer via the network, periodic system checks and other scheduled tasks. The sensor processes 708 monitor and take action based on data received from one or more sensors, e.g., activating/deactivating alarms, detecting and reporting malfunctions, collecting data readings from the one or more sensors, etc. The network processes 710 may include periodic backups, software updates, data updates, status reports, etc. The error handling processes 712 respond to various errors that may occur during operation of the system.

The access process 704 starts in block 720. User access data is received in block 722 and the access attempt information is stored in block 724. If the controller is set to local mode or local and remote mode as determined in decision block 726, the received user access data is compared to the stored access data in block 728. If the received user access data does not match the stored access data, as determined in decision block 730, access is denied in block 732 and an access denied message is sent to the security center in block 734. If a maximum number of attempts have not been reached for a time period, as determined in decision block 736, the maximum attempts for the time period information is stored in-block 738 and the access process ends in block 740. If, however, the maximum number of attempts for the time period has been reached, as determined in decision block 736, access is locked out in block 742 and the maximum number of attempts for the time period information is stored in block 744. The maximum number of attempts for the time period information is also sent to the security center in block 748 and the access process ends in block 740.

If, however, the received user access data matches the stored data in decision block 703, and the controller is not also set to remote mode, as determine in decision block 750, one or more of the lockable compartments are unlocked in block 752, a timer is started in block 754 and an access granted message is sent to the security center in block 756. After a specified time has elapsed in block 758, and if the lockable compartment 760 is closed, as determined in decision block 760, the one or more lockable compartments are locked in block 762. Access end information is stored in block 764, a compartment locked message is sent to the security center in block 766 and the access process ends in block 768. If, however, the compartment is not closed, as determined in decision block 760, and a maximum unlock time has not been exceeded, as determined in decision block 770, the controller returns to the wait period in block 758 and proceeds as previously described. If, however, the unlock time for the compartment has been exceeded, as determined in decision block 770, the time exceeded information is stored in block 772. The time exceeded information is also sent to the security center in block 774 and a warning is issued in block 776. The controller returns to the wait period in block 758 and proceeds as previously described.

If, however, the controller is set to remote mode only, as determined in decision block 726, or the controller is set to local and remote mode as determined in-decision block 750, the controller sends an access request message containing the received user access data to the security center in block 778. Once an access reply message is received from the security center in block 780 and the message indicates that access is not to be granted, as determined in decision block 782, the controller denies access in block 732 and proceeds as previously described. If, however, the message indicates that access is granted, as determined in decision block 782, the controller unlocks one or more of the compartments in block 752 and proceeds as previously described. This method can be implemented as a computer program embodied on a computer readable medium wherein each step comprised one or more code segments.

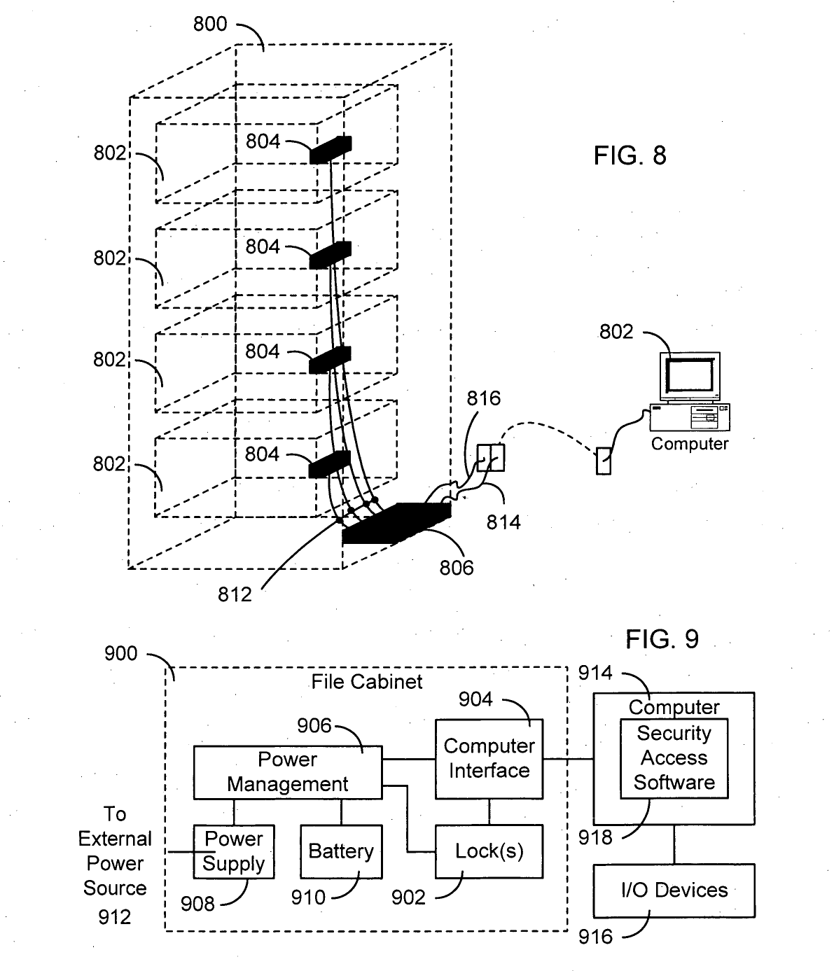

Referring now to FIG. 8, a perspective view of a cabinet 800 in accordance with one embodiment of the present invention is shown. The present invention provides a cabinet 800 that includes one or more lockable compartments 802, at least one locking/unlocking apparatus 804 for the one or more lockable compartments 802, a computer interface 806 communicably coupled to the locking/unlocking apparatus 804 and a power supply (integrated into computer interface 806) electrically connected to the at least one locking/unlocking apparatus 804 and the computer interface 806. As used herein, a cabinet 800 may include a file cabinet, a storage cabinet, a portion of a desk or any other type of office/industrial furniture that contains compartments (drawers or doors). Moreover, the cabinet 800 may be of different sizes to accommodate the different needs of the business or hospital, e.g., files, documents, receipts, samples, supplies, medicines, tools and the like. Additionally, the one or more lockable compartments 802 may be of different sizes as well. Furthermore, the size of the one or more lockable compartments 802 may vary in a cabinet 800, for example, having one or more larger lockable compartments 802 at the bottom and one or more smaller lockable compartments 802 at the top. Likewise, various components can be communicably coupled together using simple wires, communication cables, circuit board interconnects and traces, optical cables, wireless connections or any other means that allow one device to communicate with or control another device.

The locking/unlocking apparatus 804 can be any electrically operated locking mechanism, such as a solenoid driven latch, plunger or rod, an electromagnetic latch, or any other controllable locking/unlocking means. The locking/unlocking apparatus 804 can be installed in any practical location within the cabinet 800 (e.g., at the back, side, front, top or bottom of the compartment 802). Moreover, the number of locking/unlocking apparatuses 804 used will depend on the application and range from a single locking/unlocking apparatus 804 to secure all the compartments 802 in the cabinet 800 to one locking/unlocking apparatus 804 to secure each compartment 802 in the cabinet 800. Typically, the locking/unlocking apparatus 804 is selected to automatically lock when the corresponding lockable compartment 802 is closed and to remain in a normally locked position without power, which prevents access by simply interrupting the power to the cabinet 800. Each locking/unlocking apparatus 804 can be communicably connected to the user access device by individual wires 812 (e.g, 18/2). The communication can be as simple as applying voltage to a relay or solenoid, or a complex as a coded or multiplexed wireless transmission to a receiver installed on the locking/unlocking apparatus 804. For example, each locking/unlocking apparatus 804 can have a separate communication channel. Note that the computer 818 can be directly connected to the computer interface 806 via a standard communication ports/cables (e.g., USB, etc.).

The control portion of the computer interface 806 is typically located internally to the cabinet 800. The location within the cabinet 800 may be varied depending on the space available and the level of security needed. The computer interface 806 may be positioned on the underside of the cabinet 800 or on the back wall of the cabinet 800. Furthermore, a specific housing may be constructed within the cabinet 800 to accommodate the control unit. The housing may be engineered to prevent access to the control unit. The computer interface 806 simply receives a unlock message from computer 818 via a standard local area network connection 814, direct connection (e.g., USB) or wireless network connection. The components of the computer interface 806 can be integrated into a single unit or distributed within or on the cabinet 800. The cabinet may also includes a keyed lock or other security measure.

A security access software, application or driver runs on the computer 818, which receives the user access data from a user attempting to access the cabinet 800. The security access software, application or driver can be used to gain access to only a single lockable compartment 802 based on a security level associated with the user or inputs provided at the time of the access request (e.g., keypad, selection buttons, touch screen, voice command, etc.). The computer 818 may include a biometric sensor, a card reader, a keypad, a touch screen, a scanner, a wireless receiver, a wiegand reader or any combination thereof. Likewise, the user access data may include a personal identification number, a password, a fingerprint, a hand print, a voice print, an iris scan, a retina scan, a facial scan, a wireless signal or any combination thereof.

A data storage device within the computer 818 stores the received user access data, other access activity information and the user access data for one or more authorized users. The data storage device may include a memory, a hard drive, a disk drive, a database or any combination thereof. The other access activity information may include a date, an attempted access time, an unlock time, a lock time, a result of the comparison of the received user access data with the user access data for the one or more authorized users, a status of the locking/unlocking apparatus or a combination thereof. The computer 818 compares the received user access data with the user access data for the one or more authorized users and sends an unlock message to the computer interface 806 that controls the locking/unlocking apparatus 804 based on the unlock message. The unlock message can be encrypted or contain a series of special codes are will only be recognized by the computer interface 806. Other message types can also be used to perform various functions. In addition, the computer program, application or driver can be configured to communication with a single known computer interface 806. In other words, the computer interface 806 and computer program, application or driver are configured by the manufacturer and sold as a package. The computer program, application or driver can also determine which of the one or more lockable compartments 804 to unlock based on a security level associated with the user access data for the one or more authorized users. In addition, the computer program, application or driver can communicate with a building or central security center via a standard local area network connection. The computer interface 806 can also be connected to one or more sensors, such as a heat sensor, a smoke sensor, a lockable compartment position sensor, a weight sensor, a loss of power sensor, a low battery sensor, a vibration sensor, a forced entry sensor, an “open to long” sensor or any combination thereof.

The power supply may include an AC-DC converter, one or more batteries or any combination thereof. In addition, the power supply may include a power management device (integrated into computer interface 806) electrically connected to the computer interface 806 and the locking/unlocking apparatus 804, a primary power supply electrically connected to the power management device and a secondary power supply electrically connected to the power management device. The primary power supply is connected to an external power source 816, such as a building AC outlet. The secondary power supply typically comprises one or more batteries. Often such batteries will provide backup power to the system for four to six hours and are recharged when primary power is restored. A low power configuration could include low power locking/unlocking apparatus 804 that receives power from the computer interface 806 via a USB or similar type of powered communication interface. The cabinet 800 may also include various accessories as previously described herein.

Note that the user access data may be stored a token (e.g., card, badge, key, disk, hard drive, jump drive or other object capable of storing information) carried by the user or located on or about the computer 818. For example, access to a cabinet 800 may require a biometric user access data from the computer 818 (e.g., a fingerprint scan) and insert an encoded security card into a card reader. When biometric user access data is used, the level of security of the cabinet may be varied by adjusting the stringency of the match between the biometric user access data and the stored biometric access data. In addition, redundant systems may be used which would include two or more authentication comparisons. For example, the individual may be required to input a password and submit a fingerprint scan, submit a fingerprint scan and a retinal scan or require two or more individuals to submit fingerprint scans before access is granted. The redundant authentication will allow even a greater level of security.

Furthermore, the present invention provides a kit for retrofitting a cabinet having one or more compartments to a controlled access cabinet 800 having one or more lockable compartments 802. The kit includes at least one locking/unlocking apparatus 804 suitable for mounting within the cabinet 800 to convert the one or more compartments to one or more lockable compartments 802, a computer interface 806 suitable for mounting on or within the cabinet 800 to control the at least one locking/unlocking apparatus 804, and computer software, application or driver for installation on the computer 818 to control access to the cabinet. The computer 818 receives user access data. The computer 818 has a data storage device that stores the received user access data, other access activity information and user access data for one or more authorized users. The computer 818 compares the received user access data with the user access data for the one or more authorized users and controls the locking/unlocking apparatus 804 based on the comparison.

Similarly, the present invention provides a method for retrofitting a cabinet having one or more compartments to a controlled access cabinet 800 having one or more lockable compartments 802. At least one locking/unlocking apparatus 804 is installed within the cabinet 800 to convert the one or more compartments to one or more lockable compartments 802. A computer interface 806 is also installed on or within the cabinet 800. The computer interface 806 is then connected to the at least one locking/unlocking apparatus 804 such that the user access device controls the operation of the at least one locking/unlocking apparatus 804. A computer program, application or driver is installed on a computer 818 to control the computer interface 806. The user device receives user access data. The computer's data storage device stores the received user access data, other access activity information and user access data for one or more authorized users. The computer 818 compares the received user access data with the user access data for the one or more authorized users and controls the locking/unlocking apparatus 804 based on the comparison.

Now referring to FIG. 9, a block diagram of a cabinet 900 in accordance with one embodiment of the present invention is shown. The cabinet 900 includes an apparatus that controls access to the cabinet 900 having one or more lockable compartments and at least one locking/unlocking apparatus 902. The apparatus includes a computer interface 904 that is communicably coupled to the at least one locking/unlocking apparatus 902. The computer interface 904 receives an unlock message or other messages from computer 914 via a network connection, direct connection (e.g. USB) or wireless connection. The computer 914 includes various input/output (I/O) devices 916 and runs security access software, application or driver 918 that interfaces receives user access data. A data storage device connected to the computer 914 stores the received user access data, other access activity information and user access data for one or more authorized users. The computer 914 compares the received user access data with the user access data for the one or more authorized users and sends an unlock message to the computer interface 904, which controls the locking/unlocking apparatus 902 based on the comparison. This particular embodiment also includes a power management device 906 electrically connected to the at least one locking/unlocking apparatus 902, the user access device 904, a power supply 908 and one or more batteries 910. The power supply 908 is then electrically connected to an external power source 912.

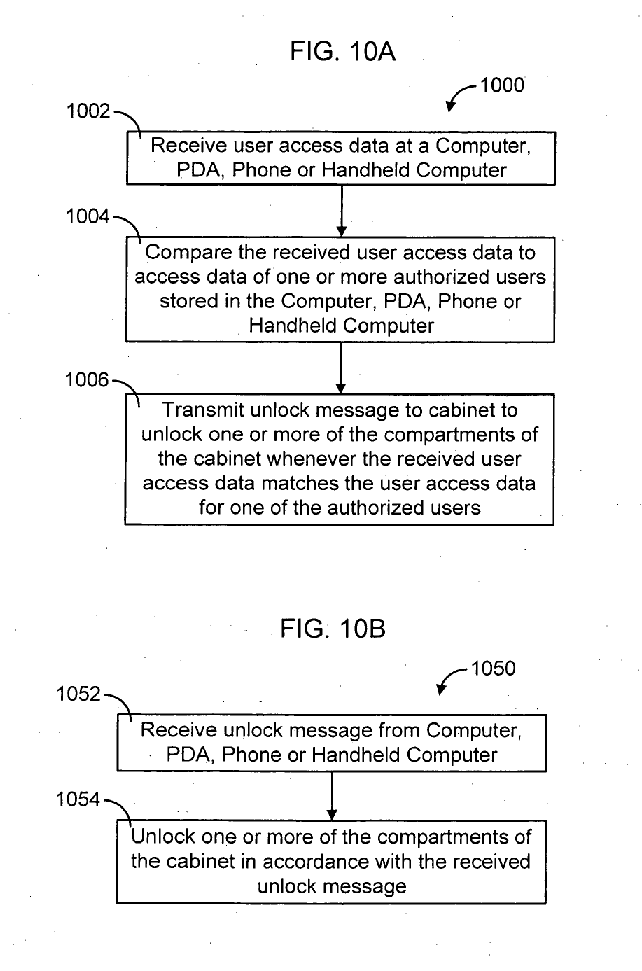

Referring now to FIGS. 10A and 10B, flow charts illustrating methods 1000 and 1050 of controlling access to a cabinet in accordance with one embodiment of the present invention are shown. As previously discussed, the cabinet has one or more lockable compartments, at least one locking/unlocking apparatus and a computer interface connected to a computer. First, user access data is received at the computer, PDA, phone or handheld computer in block 1002. The received user access data is then compared with user access data for one or more authorized users stored in the data storage device of the computer, PDA, phone or handheld computer in block 1004. A unlock message is then transmitted to the cabinet via the computer interface whenever the received user access data matches the user access data for one of the authorized users in block 1006. The received user access data and other access activity information are also stored in the data storage device. The computer interface of the cabinet receives the unlock message from the computer, PDA, phone or handheld computer in block 1052. If the unlock message is recognized and valid, one or more of the compartments of the cabinet are unlocked in accordance with the unlock message in block 1054. These methods can be implemented as a computer program embodied on a computer readable medium wherein each step comprised one or more code segments.

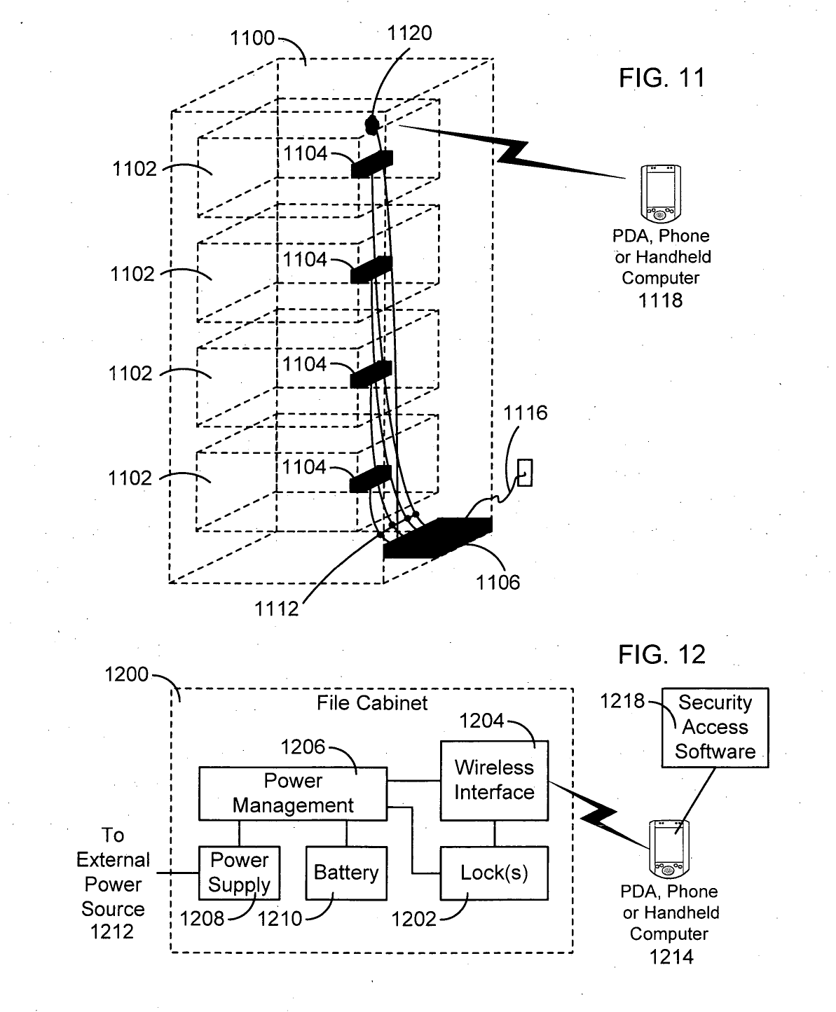

Referring now to FIG. 11, a perspective view of a cabinet 1100 in accordance with one embodiment of the present invention is shown. The present invention provides a cabinet 1100 that includes one or more lockable compartments 1102, at least one locking/unlocking apparatus 1104 for the one or more lockable compartments 1102, a wireless interface 1106 communicably coupled to the locking/unlocking apparatus 1104 and a power supply (integrated into wireless interface 1106) electrically connected to the at least one locking/unlocking apparatus 1104 and the wireless interface 1106. As used herein, a cabinet 1100 may include a file cabinet, a storage cabinet, a portion of a desk or any other type of office/industrial furniture that contains compartments (drawers or doors). Moreover, the cabinet 1100 may be of different sizes to accommodate the different needs of the business or hospital, e.g., files, documents, receipts, samples, supplies, medicines, tools and the like. Additionally, the one or more lockable compartments 1102 may be of different sizes as well. Furthermore, the size of the one or more lockable compartments 1102 may vary in a cabinet 1100, for example, having one or more larger lockable compartments 1102 at the bottom and one or more smaller lockable compartments 1102 at the top. Likewise, various components can be communicably coupled together using simple wires, communication cables, circuit board interconnects and traces, optical cables, wireless connections or any other means that allow one device to communicate with or control another device. Cabinet 1100 may also include an antenna, optical receiver, RFID receiver or cable connection 1120 that is communicably connected to the wireless interface 1106, which in some of the cases is really a communications interface instead of a wireless interface. The wireless interface 1106 and antenna, optical receiver, RFID receiver or cable connection (e.g., network, USB, etc.) 1120 can also be integrated into a single device that can be installed within an appropriate location within the cabinet 1100 (e.g., at 1106 or 1120).

The locking/unlocking apparatus 1104 can be any electrically operated locking mechanism, such as a solenoid driven latch, plunger or rod, an electromagnetic latch, or any other controllable locking/unlocking means. The locking/unlocking apparatus 1104 can be installed in any practical location within the cabinet 1100 (e.g., at the back, side, front, top or bottom of the compartment 1102). Moreover, the number of locking/unlocking apparatuses 1104 used will depend on the application and range from a single locking/unlocking apparatus 1104 to secure all the compartments 1102 in the cabinet 1100 to one locking/unlocking apparatus 1104 to secure each compartment 1102 in the cabinet 1100. Typically, the locking/unlocking apparatus 1104 is selected to automatically lock when the corresponding lockable compartment 1102 is closed and to remain in a normally locked position without power, which prevents access by simply interrupting the power to the cabinet 1100. Each locking/unlocking apparatus 1104 can be communicably connected to the user access device by individual wires 1112 (e.g. 18/2). The communication can be as simple as applying voltage to a relay or solenoid, or a complex as a coded or multiplexed wireless transmission to a receiver installed on the locking/unlocking apparatus 1104. For example, each locking/unlocking apparatus 1104 can have a separate communication channel. Note that the PDA, phone or handheld computer 11 18 can be directly connected to the wireless interface 1106 via a standard communication ports/cables (e.g., USB, etc.).

The control portion of the wireless interface 1106 is typically located internally to the cabinet 1100. The location within the cabinet 1100 may be varied depending on the space available and the level of security needed. The wireless interface 1106 may be positioned on the underside of the cabinet 1 100 or on the back wall of the cabinet 1 100. Furthermore, a specific housing may be constructed within the cabinet 1100 to accommodate the control unit. The housing may be engineered to prevent access to the control unit. The wireless interface 1106 simply receives a unlock message from PDA, phone or handheld computer 1118 via antenna, optical receiver, RFID receiver or cable connection (e.g., network, USB, etc.) 1120. The components of the wireless interface 1106 can be integrated into a single unit or distributed within or on the cabinet 1100. The cabinet may also includes a keyed lock or other security measure.

A security access software, application or driver runs on the PDA, phone or handheld computer 1118, which receives the user access data from a user attempting to access the cabinet 1100. The security access software, application or driver can be used to gain access to only a single lockable compartment 1102 based on a security level associated with the user or inputs provided at the time of the access request (e.g., keypad, selection buttons, touch screen, voice command, etc.). The PDA, phone or handheld computer 1118 may include a biometric sensor, a card reader, a keypad, a touch screen, a scanner, a wireless receiver, a wiegand reader or any combination thereof. Likewise, the user access data may include a personal identification number, a password, a fingerprint, a hand print, a voice print, an iris scan, a retina scan, a facial scan, a wireless signal or any combination thereof.

A data storage device within the PDA, phone or handheld computer 1118 stores the received user access data, other access activity information and the user access data for one or more authorized users. The data storage device may include a memory, a hard drive, a disk drive, a database or any combination thereof. The other access activity information may include a date, an attempted access time, an unlock time, a lock time, a result of the comparison of the received user access data with the user access data for the one or more authorized users, a status of the locking/unlocking apparatus or a combination thereof. The PDA, phone or handheld computer 1118 compares the received user access data with the user access data for the one or more authorized users and sends an unlock message to the wireless interface 1106 that controls the locking/unlocking apparatus 1104 based on the unlock message. The unlock message can be encrypted or contain a series of special codes are will only be recognized by the wireless interface 1106. Other message types can also be used to perform various functions. In addition, the computer program, application or driver can be configured to communication with a single known wireless interface 1106. In other words, the wireless interface 1106 and computer program, application or driver are configured by the manufacturer and sold as a package. The computer program, application or driver can also determine which of the one or more lockable compartments 1104 to unlock based on a security level associated with the user access data for the one or more authorized users. In addition, the computer program, application or driver can communicate with a building or central security center via a standard local area network connection. The wireless interface 1106 can also be connected to one or more sensors, such as a heat sensor, a smoke sensor, a lockable compartment position sensor, a weight sensor, a loss of power sensor, a low battery sensor, a vibration sensor, a forced entry sensor, an “open to long” sensor or any combination thereof.

The power supply may include an AC-DC converter, one or more batteries or any combination thereof. In addition, the power supply may include a power management device (integrated into wireless interface 1106) electrically connected to the wireless interface 1106 and the locking/unlocking apparatus 1104, a primary power supply electrically connected to the power management device and a secondary power supply electrically connected, to the power management device. The primary power supply is connected to an external power source 1116, such as a building AC outlet. The secondary power supply typically comprises one or more batteries. Often such batteries will provide backup power to the system for four to six hours and are recharged when primary power is restored. A low power configuration could include low power locking/unlocking apparatus 1104 that receives power from the wireless interface 1106 via a USB or similar type of powered communication interface. The cabinet 1100 may also include various accessories as previously described herein.

Note that the user access data may be stored a token (e.g., card, badge, key, disk, hard drive, jump drive or other object capable of storing information) carried by the user or located on or about the PDA, phone or handheld computer 1118. For example, access to a cabinet 1100 may require a biometric user access data from the PDA, phone or handheld computer 1118 (e.g., a fingerprint scan) and insert an encoded security card into a card reader. When biometric user access data is used, the level of security of the cabinet may be varied by adjusting the stringency of the match between the biometric user access data and the stored biometric access data. In addition, redundant systems may be used which would include two or more authentication comparisons. For example, the individual may be required to input a password and submit a fingerprint scan, submit a fingerprint scan and a retinal scan or require two or more individuals to submit fingerprint scans before access is granted. The redundant authentication will allow even a greater level of security.

Furthermore, the present invention provides a kit for retrofitting a cabinet having one or more compartments to a controlled access cabinet 1100 having one or more lockable compartments 1102. The kit includes at least one locking/unlocking apparatus 1104 suitable for mounting within the cabinet 1100 to convert the one or more compartments to one or more lockable compartments 1102, a wireless interface 1106 suitable for mounting on or within the cabinet 1100 to control the at least one locking/unlocking apparatus 1104, and computer software, application or driver for installation on the PDA, phone or handheld computer 1118 to control access to the cabinet. An antenna, optical receiver, RFID receiver or cable connection 1120 may also be included. The PDA, phone or handheld computer 1118 receives user access data. The PDA, phone or handheld computer 1118 has a data storage device that stores the received user access data, other access activity information and user access data for one or more authorized users. The PDA, phone or handheld computer 1118 compares the received user access data with the user access data for the one or more authorized users and controls the locking/unlocking apparatus 1104 based on the comparison.

Similarly, the present invention provides a method for retrofitting a cabinet having one or more compartments to a controlled access cabinet 1100 having one or more lockable compartments 1102. At least one locking/unlocking apparatus 1104 is installed within the cabinet 1100 to convert the one or more compartments to one or more lockable compartments 1102. A wireless interface 1106 is also installed on or within the cabinet 1100. The wireless interface 1106 is then connected to the at least one locking/unlocking apparatus 1104 such that the user access device controls the operation of the at least one locking/unlocking apparatus 1104. An antenna, optical receiver, RFID receiver or cable connection 1120 may also be included. A computer program, application or driver is installed on a PDA, phone or handheld computer 1118 to control the wireless interface 1106. The user device receives user access data. The computer's data storage device stores the received user access data, other access activity information and user access data for one or more authorized users. The PDA, phone or handheld computer 1118 compares the received user access data with the user access data for the one or more authorized users and controls the locking/unlocking apparatus 1104 based on the comparison.

Now referring to FIG. 12, a block diagram of a cabinet 1200 in accordance with one embodiment of the present invention is shown. The cabinet 1200 includes an apparatus that controls access to the cabinet 1200 having one or more lockable compartments and at least one locking/unlocking apparatus 1202. The apparatus includes a wireless interface 1204 that is communicably coupled to the at least one locking/unlocking apparatus 1202. The wireless interface 1204 receives an unlock message or other messages from PDA, phone or handheld computer 1214. The PDA, phone or handheld computer 1214 runs security access software, application or driver 1218 that interfaces receives user access data. A data storage device connected to the PDA, phone or handheld computer 1214 stores the received user access data, other access activity information and user access data for one or more authorized users. The PDA, phone or handheld computer 1214 compares the received user access data with the user access data for the one or more authorized users and sends an unlock message to the wireless interface 1204, which controls the locking/unlocking apparatus 1202 based on the comparison. This particular embodiment also includes a power management device 1206 electrically connected to the at least one locking/unlocking apparatus 1202, the user access device 1204, a power supply 1208 and one or more batteries 1210. The power supply 1208 is then electrically connected to an external power source 1212. Note that the present invention could be implemented using a RFID transceiver 1204 that unlocks the locking/unlocking apparatus 1202 in response to the presence of a RFID card or device (powered or unpowered).

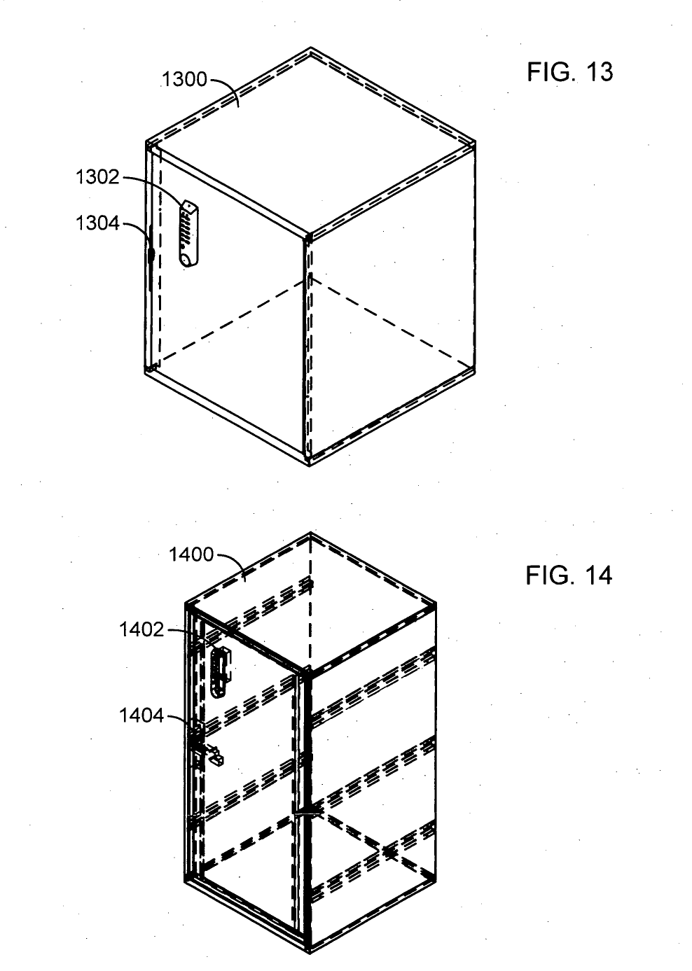

Referring now to FIG. 13, an isometric view of controlled access cabinet 1300 in accordance with one embodiment of the present invention is shown. The controlled access cabinet 1300 includes a controller 1302 (e.g., CompX Security Products item number EL-2004-KP) that controls the locking/unlocking apparatus 1304 (e.g., self locking gear driven bolt, such as CompX Security Products item number EL-2004-ML). Additional information about CompX electronic controls, locks and bolts can be found at http://www.compxnet.com/elocknum.asp#num, which the contents of which are hereby incorporated by reference. Other electronic locks can also be used. As shown, the controller 1302 includes a keypad, but may also include any of the previously described components. These types of cabinets can solve compliance issues for HIPPA, privacy laws, liability, human resources, FERPA, Sarbanes-Oxley and other regulated compliance laws and regulations. For example, cabinets in accordance with the present invention can protect and securely, store important information, such as medical records, employment records, tax records, customer information, education records, bank records, signature cards, credit applications, test books/answer sheets, cash drawers, evidence storage, office and computer equipment, software, etc. Moreover, the cabinets can be self-locking (when drawer or door is closed), time zone controlled, store user audit control and provide multiple access capability.

Now referring to FIG. 14, an isometric view of controlled access cabinet 1400 in accordance with another embodiment of the present invention is shown. The controlled access cabinet 1400 includes a controller 1402 (e.g., CompX Security Products item number EL-2004-KP) that controls the locking/unlocking apparatus 1404 (e.g., self locking gear driven bolt associated with CompX Security Products item number EL-2004-KP). Additional information about CompX electronic locks can be found at http://www.compxnet.com/elocknum.asp#num, which the contents of which are hereby incorporated by reference. Other electronic locks can also be used. As shown, the controller 1402 includes a keypad, but may also include any of the previously described components.

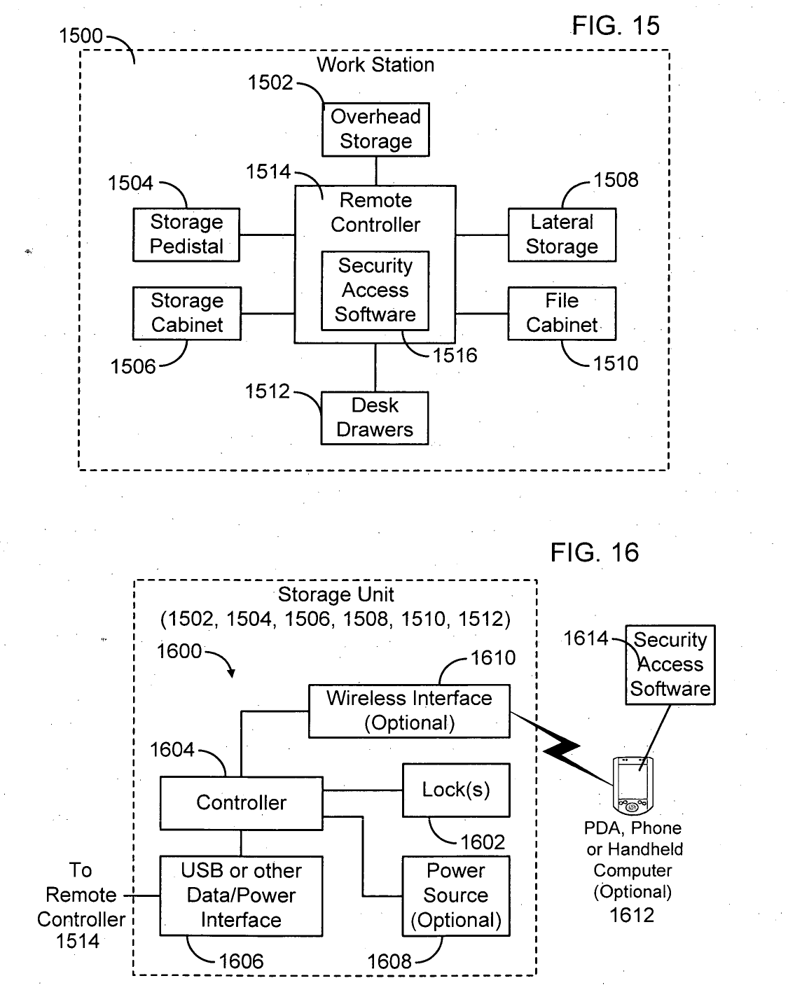

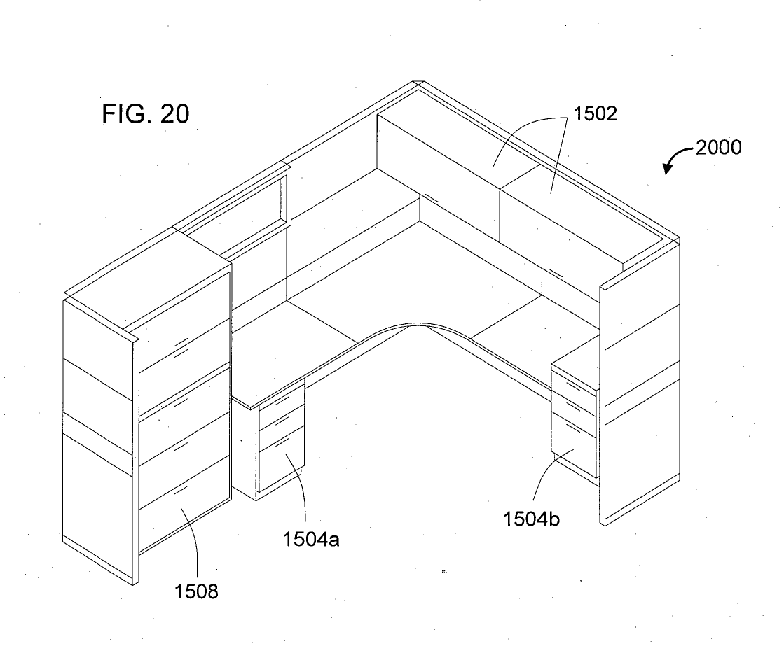

The present invention will now be described in reference to modular storage units within modular workstations in FIGS. 15-23. Note that the concepts, methods, devices and systems disclosed above in reference to FIGS. 1-14 can be applied to modular workstations even though they may not be expressly stated below in the description of FIGS. 15-23.

Referring now to FIG. 15, a block diagram of a modular workstation 1500 in accordance with one embodiment of the present invention is shown. The modular workstation 1500 includes one or more modular storage units, such as overhead storage units 1502, storage pedestals 1504, storage cabinets 1506, lateral storage units 1508, file cabinets 1510 or desk drawers 1512. Each modular storage unit 1502-1512 includes one or more lockable compartments (e.g., door, drawer, etc.), at least one locking/unlocking apparatus (e.g., self locking gear driven bolt assembly) for the one or more lockable compartments, a unit controller and a power supply electrically connected to the at least one locking/unlocking apparatus and the unit controller. The lockable compartments can be individually lockable or all locked with a single mechanism. The unit controller is communicably coupled to the locking/unlocking apparatus and receives a message from a remote controller 1514 running security access software 1516 and controls the locking/unlocking apparatus based on the message. In addition, the remote controller 1514 can be a user device (e.g., computer, personal data assistant (“PDA”), phone, handheld computer, radio frequency identification device (“RFID”), etc.), network device (e.g., network node, network controller, a server, etc.) or a combination thereof. The remote controller 1514 stores one or more security profiles containing user access data for one or more authorized users, one or more trigger event/action protocols, other access activity information or a combination thereof. The user access data may include a personal identification number, a password, a fingerprint, a hand print, a voice print, an iris scan, a retina scan, a facial scan, a wireless signal, a user device status or a combination thereof. The other access activity information may include a date, an attempted access time, an unlock time, a lock time, a result of the comparison of the received user access data with the user access data for the one or more authorized users, a status of the locking/unlocking apparatus or a combination thereof. The unit controller may receive the message via a network cable, USB type cable or wireless communication link. The power supply may include an AC-DC converter, one or more batteries, a USB type connection or a combination thereof.

Now referring to FIG. 16, a block diagram of a unit controller 1600 within a modular storage unit 1502-1512 in accordance with one embodiment of the present invention is shown. The unit controller 1600 includes an apparatus that controls access to the modular storage unit 1502-1512 having one or more lockable compartments and at least one locking/unlocking apparatus 1602 (e.g., self locking gear driven bolt assembly). The unit controller 1600 includes a USB or other data/power interface 1606 communicably coupled to a controller 1604 and one or more locking/unlocking apparatus 1602 communicably coupled to the controller 1604. The USB or other data/power interface 1606 is communicably coupled to a remote controller 1514 via a communications network (e.g., router, computer, wireless network, wired network, etc.). In the case of a USB type connection, the controller 1604 can receive sufficient power to control the locking/unlocking apparatus 1602. Alternatively, an optional power source or supply 1608 can be electrically connected to the controller 1604 and locking/unlocking apparatus 1602. The power supply 1608 may include an AC-DC converter, one or more batteries or a combination thereof. The power supply 1608 may also include a power management device electrically connected to the controller 1604 and the locking/unlocking apparatus 1602, a primary power supply electrically connected to the power management device, and a secondary power supply electrically connected to the power management device. Moreover, the unit controller 1600 may include an optional wireless interface 1610 that is communicably coupled to the controller 1604. The wireless interface 1610 receives an unlock message or other messages from PDA, phone or handheld computer 1612. The PDA, phone or handheld computer 1612 runs security access software, application or driver 1614 that determines whether or not to send the message to the controller 1614 via wireless interface 1610. A data storage device connected to the PDA, phone or handheld computer 1612 stores one or more security profiles containing user access data for one or more authorized users, one or more trigger event/action protocols, other access activity information or a combination thereof.

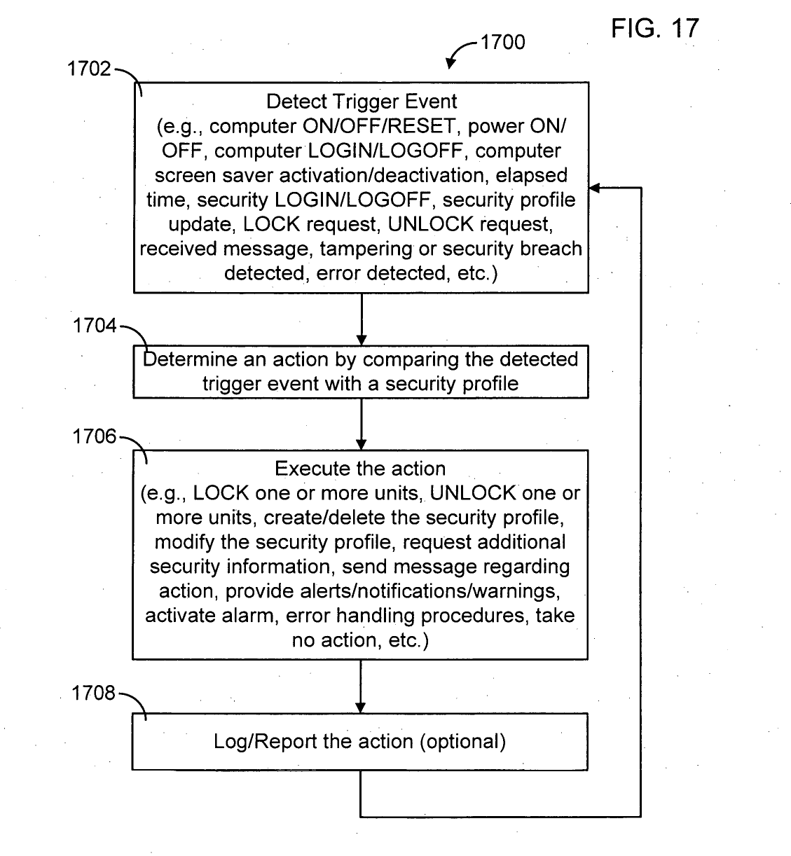

Referring now to FIG. 17, a flow chart illustrating a method 1700 of controlling access to one or more modular storage units within a modular workstation in accordance with one embodiment of the present invention is shown. Each modular storage unit includes one or more lockable compartments, at least one locking/unlocking apparatus and a unit controller. The method 1700 includes detecting a trigger event in block 1702, determining an action by comparing the detected trigger event with a security profile in block 1704, executing the action in block 1706, and logging/reporting (optional) in block 1708. This process repeats whenever the security access software is running and a trigger event is detected. The trigger event may include a computer on/off/restart, a power on/off, a computer screen saver activation/deactivation, an elapsed time, a security login/logoff, a security profile update, a lock request, an unlock request, a received message, a tampering detection, a security breach detection or an error detection. The action may include the steps of locking one or more of the lockable compartments, unlocking one or more of the lockable compartments, creating or deleting the security profile, modifying the security profile, requesting additional security information, send message, providing alerts/notifications/warnings, activating an alarm, handling one or more errors or taking no action. This method can be implemented as a computer program embodied on a computer readable medium wherein each step comprised one or more code segments.

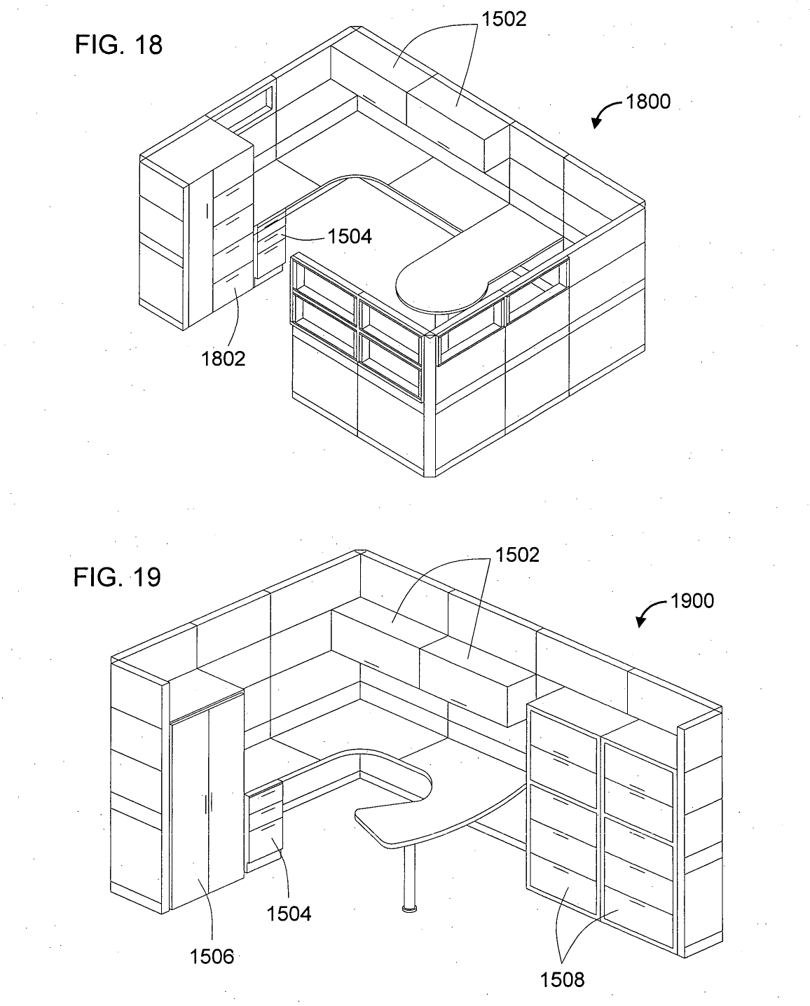

Now referring to FIGS. 18, 19 and 20, isometric views of modular workstations 1800, 1900 and 2000 in accordance with various embodiments of the present invention are shown. For example, modular workstation 1800 includes a coat and storage unit 1802, two overhead storage units 1502 and a storage pedestal 1504. As previously described, these modular storage units 1502, 1504 and 1802 are communicably coupled to a computer (not shown) via a communications network (not shown). The computer can be a desktop computer, laptop computer, handheld computer, PDA, phone or other device running security access software. The communications network can be one or more communication cables, a wired network, a wireless network or combination thereof. The security access software can be configured to operate in many different modes and different users based on security profiles. For example, all the modular storage units 1502, 1504 and 1802 can remain unlocked while the user is working on the computer, but automatically lock when the user logs off, turns off or resets the computer. Moreover, modular storage units 1502, 1504 and 1802 can be locked automatically when the computer screen saver is activated or a specified time period of computer inactivity has elapsed. Furthermore, the modular storage units 1502, 1504 and 1802 (including each drawer or door) can be assigned different security levels (e.g., always unlocked, unlocked when computer is on, unlocked when computer activity is detected, unlocked only upon specific request and additional user authentication, etc.). Similarly, modular workstation 1900 includes two overhead storage units 1502, a storage pedestal 1504, a storage cabinet 1506 and two lateral storage units 1508. Likewise, modular workstation 2000 includes two overhead storage units 1502, two storage pedestals 1504a and 1504b and a lateral storage unit 1508.

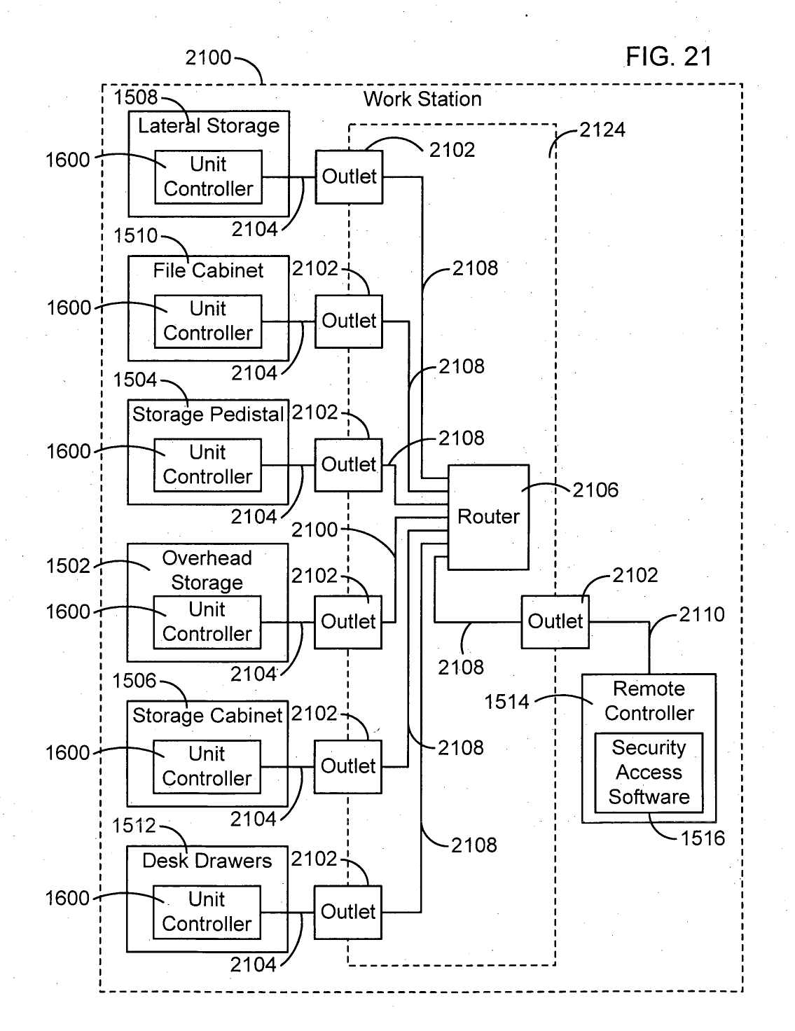

Referring now to FIG. 21, a block diagram of a system for controlling access to one or more modular storage units 1502-1512 within a modular workstation 2100 in accordance with one embodiment of the present invention is shown. The system includes the one or more modular storage units 1502-1512, a communications network 2124 and a remote controller 1514 (e.g. user device, network controller, etc.) running security access software 1516. Each modular storage unit 1502-1512 includes one or more lockable compartments, at least one locking/unlocking apparatus (e.g., self locking gear driven bolt assembly) for the one or more lockable compartments, and a unit controller communicably coupled to the locking/unlocking apparatus that receives a message from the remote controller 1514 via the communications network 2124 and controls the locking/unlocking apparatus based on the message. The communications network 2124 in this example is modular and similar to modular power distribution connections in modular workstations 2100. Communications network 2124 includes several outlets 2102 connected by communications cable 2108 to router 2106. The lock or unit controller 1600 of each modular storage unit 1502-1512 is connected to the communications network outlet 2102 with communications cable 2104. Similarly, remote controller 1514 is connected to a communications network outlet 2102 with communications cable 2104. Note that communications cables 2104 and 2108 may also supply power to the lock or unit controllers 1600 using a USB type cable.

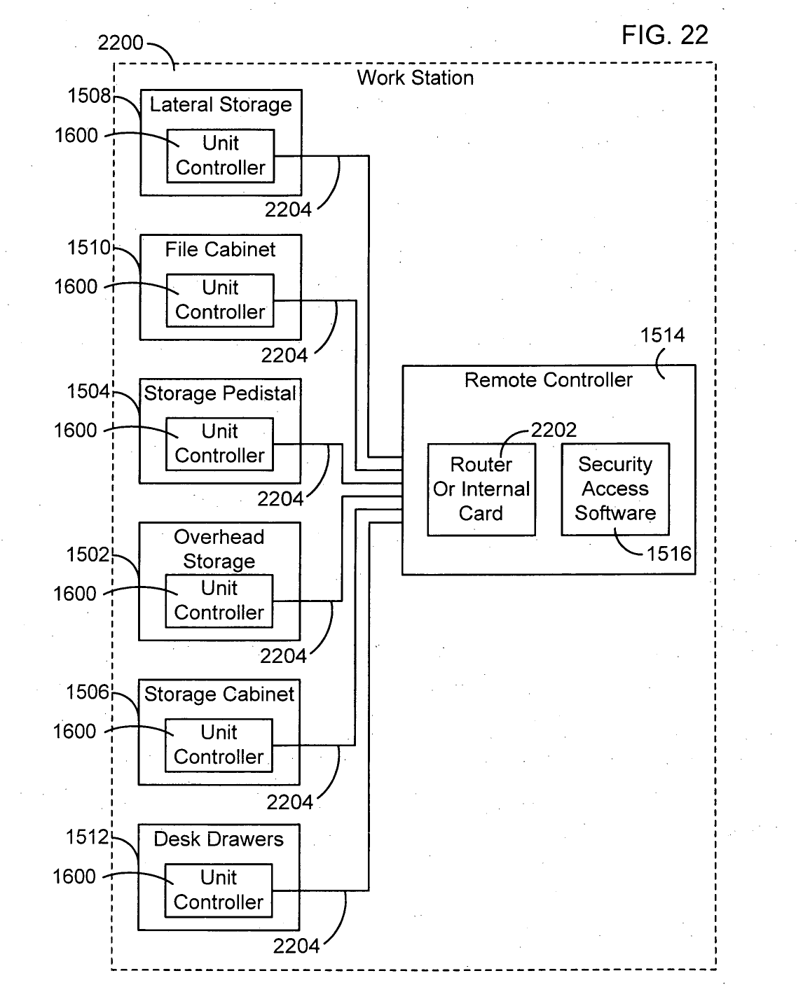

Now referring to FIG. 22, a block diagram of a system for controlling access to one or more modular storage units 1502-1512 within a modular workstation 2200 in accordance with another embodiment of the present invention is shown. The system includes the one or more modular storage units 1502-1512, a communications network (communication cables 2204 and router or internal card 2202) and a remote controller 1514 running security access software 1516. Each modular storage unit 1502-1512 includes one or more lockable compartments, at least one locking/unlocking apparatus (e.g., self locking gear driven bolt assembly) for the one or more lockable compartments, and a unit controller communicably coupled to the locking/unlocking apparatus that receives a message from the remote controller 1514 via the communications network 2204 and 2202 and controls the locking/unlocking apparatus based on the message. The communications network 2204 in this example is modular and similar to modular power distribution connections in modular workstations 2200. Note that communications cables 2204 may also supply power to the lock or unit controllers 1600 using a USB type cable.

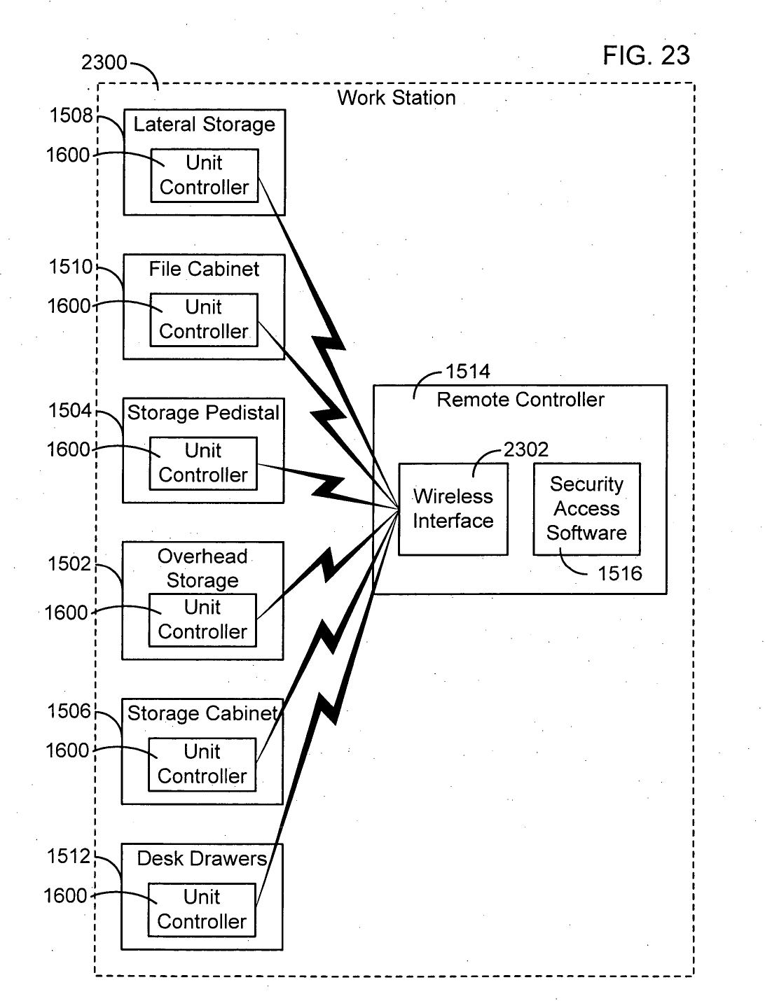

Referring now to FIG. 23, a block diagram of a system for controlling access to one or more modular storage units 1502-1512 within a modular workstation 2300 in accordance with yet another embodiment of the present invention is shown. The system includes the one or more modular storage units 1502-1512, a wireless communications network (communication links and wireless interface 2302) and a remote controller 1514 running security access software 1516. Each modular storage unit 1502-1512 includes one or more lockable compartments, at least one locking/unlocking apparatus (e.g., self locking gear driven bolt assembly) for the one or more lockable compartments, and a unit controller communicably coupled to the locking/unlocking apparatus that receives a message from the remote controller 1514 via the communications network 2302 and controls the locking/unlocking apparatus based on the message.

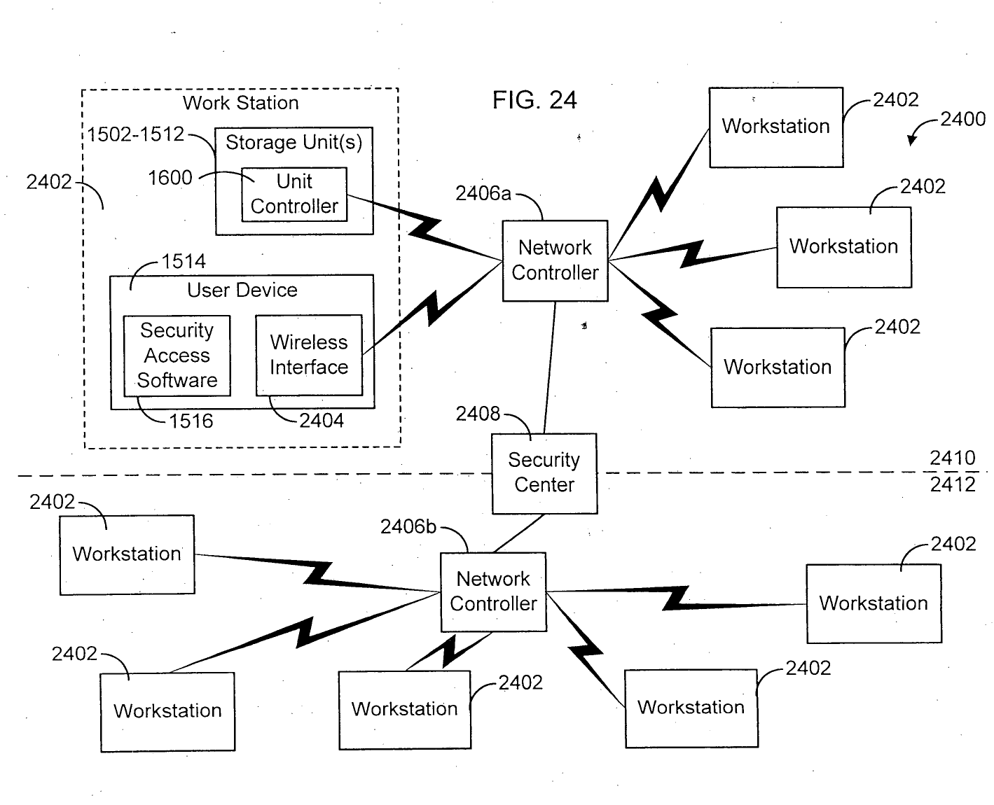

Now referring to FIG. 24, a block diagram of a system 2400 for controlling access to one or more modular storage units 1502-1512 within two groups (2410, 1412) of modular workstations 2402 in accordance with yet another embodiment of the present invention is shown. The system 2400 includes a first group 2410 of workstations 2402 that are communicably coupled to network controller 2406a and a second group 2412 of workstations 2402 that are communicably coupled to network controller 2406b. The network controllers 2406a and 2406b are communicably coupled to security center 2408. One example of a suitable network controller is the International Electronics, Inc. (IEI) main controller IE-EMRG440 with expansion module IE-EMRGEXN (expansion node card). Additional information about IEI integrated security management systems can be found at http://www.ieib.com/, which the contents of which are hereby incorporated by reference. Other network controllers can also be used. In addition, each workstation 2402 includes one or more modular storage units 1502-1512, which each have a unit controller 1600 communicably coupled to a network controller 2406. Each modular storage unit 1502-1512 includes one or more lockable compartments, at least one locking/unlocking apparatus (e.g., self locking gear driven bolt assembly) for the one or more lockable compartments, and a unit controller 1600 communicably coupled to the locking/unlocking apparatus that receives a message from the network controller 2406 and controls the locking/unlocking apparatus based on the message. A user device 1514 running security access software 1516 is assigned to each workstation 2402. User device 1514 also includes wireless interface 2404 that is communicably coupled to a remote controller 2406.

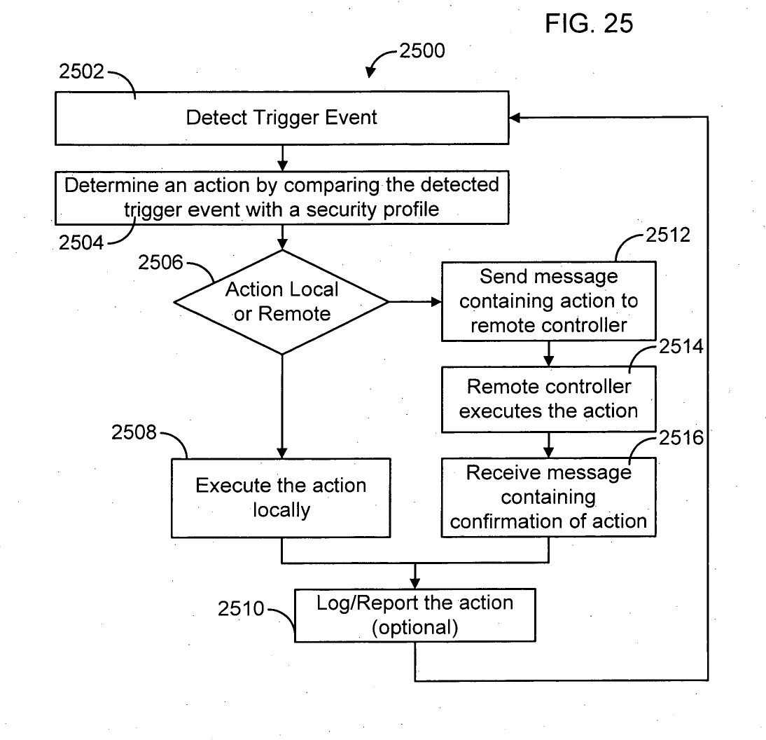

Referring now to FIG. 25, a flow chart illustrating a method 2500 of controlling access to one or more modular storage units within a modular workstation in accordance with one embodiment of the present invention is shown. Each modular storage unit includes one or more lockable compartments, at least one locking/unlocking apparatus and a unit controller. The method 1500 includes detecting a trigger event in block 1502 and determining an action by comparing the detected trigger event with a security profile in block 1504. If the action is to be executed locally, as determined in decision block 2506, the action is executed locally in block 2508 and the action logged/reported (optional) in block 2510. If, however, the action is to be executed remotely, as determined in decision block 2506, a message containing the action is sent to the remote controller in block 2512 and the remote controller executes the action in block 2514. A message is then received containing confirmation of the action in block 2516 and action logged/reported (optional) in block 2510. This process repeats whenever the security access software is running and a trigger event is detected. The trigger event may include a computer on/off/restart, a power on/off, a computer screen saver activation/deactivation, an elapsed time, a security login/logoff, a received message, a security profile update, a lock request, an unlock request, a received message, a tampering detection, a security breach detection or an error detection. The action may include the steps of locking one or more of the lockable compartments, unlocking one or more of the lockable compartments, creating or deleting the security profile, modifying the security profile, requesting additional security information, send message, providing alerts/notifications/warnings, activating an alarm, handling one or more errors or taking no action. This method can be implemented as a computer program embodied on a computer readable medium wherein each step comprised one or more code segments.

In addition, the present invention provides a kit for retrofitting a modular workstation having one or more modular storage units with one or more compartments to a controlled access modular workstation having one or more lockable compartments. The kit includes at least one locking/unlocking apparatus, a unit controller and a computer program. Each locking/unlocking apparatus is suitable for mounting within each modular storage unit to convert the one or more compartments to one or more lockable compartments. The unit controller is suitable for mounting on or within each modular storage unit to control the at least one locking/unlocking apparatus based on a message received from a remote controller. The computer program is for the remote controller to determine whether or not to send the message to the unit controller. The message includes an instruction to lock or unlock one or more of the lockable compartments or information that can be used to determine whether to lock or unlock one or more of the lockable compartments.

The present invention also provides a method for retrofitting a modular workstation having one or more modular storage units with one or more compartments to a controlled access modular workstation having one or more lockable compartments. The method includes installing at least one locking/unlocking apparatus within each modular storage unit to convert the one or more compartments to one or more lockable compartments, installing a unit controller on or within each modular storage unit, connecting the unit controller to the at least one locking/unlocking apparatus such that the unit controller controls the operation of the at least one locking/unlocking apparatus in response to a message from a remote controller, installing a computer program on the remote controller to determine whether or not to send the message to the unit controller. The message includes an instruction to lock or unlock one or more of the lockable compartments or information that can be used to determine whether to lock or unlock one or more of the lockable compartments.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

1. A modular storage unit comprising:
one or more lockable compartments;
at least one locking/unlocking apparatus for the one or more lockable compartments;
a unit controller communicably coupled to the locking/unlocking apparatus that receives a message from a remote controller and controls the locking/unlocking apparatus based on the message; and
a power supply electrically connected to the at least one locking/unlocking apparatus and the unit controller.

2. The modular storage unit as recited in claim 1, wherein the modular storage unit comprises an overhead storage unit, a storage pedestal, a storage cabinet, a lateral storage unit, a file cabinet or a desk drawer.

3. The modular storage unit as recited in claim 1, wherein the one or more lockable compartments comprise a door or a drawer.

4. The modular storage unit as recited in claim 1, wherein the remote controller comprises a user device, a network device or a combination thereof.

5. The modular storage unit as recited in claim 4, wherein:
the user device comprises a computer, a personal data assistant, a phone, a handheld computer, a radio frequency identification device or a combination thereof; and
the network device comprises a network node, a network controller, a server or a combination thereof.

6. The modular storage unit as recited in claim 1, wherein the message comprises an instruction to lock or unlock one or more of the lockable compartments or information that can be used to determine whether to lock or unlock one or more of the lockable compartments.

7. The modular storage unit as recited in claim 1, wherein the remote controller stores one or more security profiles containing user access data for one or more authorized users, one or more trigger event/action protocols, other access activity information or a combination thereof.

8. The modular storage unit as recited in claim 7, wherein:
the user access data comprises a personal identification number, a password, a fingerprint, a hand print, a voice print, an iris scan, a retina scan, a facial scan, a wireless signal, a user device status or a combination thereof; and
the other access activity information comprises a date, an attempted access time, an unlock time, a lock time, a status of the locking/unlocking apparatus or a combination thereof.

9. The modular storage unit as recited in claim 1, wherein the unit controller receives the message via a network cable, USB type cable or wireless communication link.

10. The modular storage unit as recited in claim 1, wherein the power supply comprises:
a power management device electrically connected to the unit controller and the locking/unlocking apparatus;
a primary power supply electrically connected to the power management device; and
a secondary power supply electrically connected to the power management device.

11. The modular storage unit as recited in claim 1, wherein the power supply comprises an AC-DC converter, one or more batteries, a USB type connection or a combination thereof.

12. A modular workstation comprising one or more modular storage units as recited in claim 1.

13. A system for controlling access to one or more modular storage units within one or more modular workstations, comprising
a remote controller;
each modular storage unit comprising:
one or more lockable compartments,
at least one locking/unlocking apparatus for the one or more lockable compartments, and a unit controller communicably coupled to the locking/unlocking apparatus that receives a message from the remote controller and controls the locking/unlocking apparatus based on the message; and
a communications network communicably coupling the remote controller to the unit controller of each modular storage unit.

14. The system as recited in claim 13, wherein the remote controller comprises a user device, a network device or a combination thereof.

15. The system as recited in claim 14, wherein:
the user device comprises a computer, a personal data assistant, a phone, a handheld computer, a radio frequency identification device or a combination thereof; and
the network device comprises a network node, a network controller, a server or a combination thereof.

16. The system as recited in claim 13, wherein the communications network comprises one or more communication cables, a wired network, a wireless network or combination thereof.

17. The system as recited in claim 13, wherein the message comprises an instruction to lock or unlock one or more of the lockable compartments or information that can be used to determine whether to lock or unlock one or more of the lockable compartments.

18. The system as recited in claim 13, wherein the remote controller stores one or more security profiles containing user access data for one or more authorized users, one or more trigger event/action protocols, other access activity information or a combination thereof.

19. The system as recited in claim 18, wherein:
the user access data comprises a personal identification number, a password, a fingerprint, a hand print, a voice print, an iris scan, a retina scan, a facial scan, a wireless signal, a user device status or a combination thereof; and
the other access activity information comprises a date, an attempted access time, an unlock time, a lock time, a status of the locking/unlocking apparatus or a combination thereof.

20. An apparatus for controlling access to a modular storage unit having one or more lockable compartments and at least one locking/unlocking apparatus, comprising a unit controller that receives a message from a remote controller and controls the locking/unlocking apparatus based on the message.

21. A method for controlling access to a modular storage unit having one or more lockable compartments, at least one locking/unlocking apparatus and a unit controller, the method comprising the steps of:
receiving a message from a remote controller; and
controlling at least one of the lockable compartments based on the received message.

22. The method as recited in claim 21, wherein the message comprises an instruction to lock or unlock one or more of the lockable compartments or information that can be used to determine whether to lock or unlock one or more of the lockable compartments.

23. The method as recited in claim 21, further comprising the steps of:
detecting a trigger event at the remote controller;
determining an action by comparing the detected trigger event with a security profile; and
executing the action.

24. The method as recited in claim 23 wherein:
the trigger event comprises a computer on/off/restart, a power on/off, a computer screen saver activation/deactivation, an elapsed time, a security login/logoff, a received message, a security profile update, a lock request, an unlock request, a tampering detection, a security breach detection or an error detection; and
the action comprises the steps of locking one or more of the lockable compartments, unlocking one or more of the lockable compartments, creating or deleting the security profile, modifying the security profile, requesting additional security information, sending a message, providing alerts/notifications/warnings, activating an alarm, handling one or more errors or taking no action.

25. The method as recited in claim 23, wherein:
the action comprises locking or unlocking one or more of the lockable compartments;
the step of executing the action comprises sending an unlock message to the unit controller whenever the trigger event indicates that one or more of the lockable compartments should be unlocked; and
the step of executing the action comprises sending a lock message to the unit controller whenever the trigger event indicates that one or more of the lockable compartments should be locked.

26. The method as recited in claim 21, wherein the unit controller receives the message via a network cable, USB type cable or wireless communication link.

27. The method as recited in claim 21, further comprises the steps of:
detecting a trigger event at a user device;
determining whether the action is to executed locally or remote;
executing the action at the user device whenever the action is to be executed locally; and
sending a message containing the action to the remote controller whenever the action is to be executed remotely.

28. A kit for retrofitting a modular workstation having one or more modular storage units with one or more compartments to a controlled access modular workstation having one or more lockable compartments, comprising:
at least one locking/unlocking apparatus suitable for mounting within each modular storage unit to convert the one or more compartments to one or more lockable compartments;
a unit controller suitable for mounting on or within each modular storage unit to control the at least one locking/unlocking apparatus based on a message received from a remote controller; and
a computer program for the remote controller to determine whether or not to send the message to the unit controller wherein the message comprises an instruction to lock or unlock one or more of the lockable compartments or information that can be used to determine whether to lock or unlock one or more of the lockable compartments.

29. A method for retrofitting a modular workstation having one or more modular storage units with one or more compartments to a controlled access modular workstation having one or more lockable compartments, comprising:
installing at least one locking/unlocking apparatus within each modular storage unit to convert the one or more compartments to one or more lockable compartments;
installing a unit controller on or within each modular storage unit;
connecting the unit controller to the at least one locking/unlocking apparatus such that the unit controller controls the operation of the at least one locking/unlocking apparatus in response to a message from a remote controller; and
installing a computer program on the remote controller to determine whether or not to send the message to the unit controller wherein the message comprises an instruction to lock or unlock one or more of the lockable compartments or information that can be used to determine whether to lock or unlock one or more of the lockable compartments.

30. A computer program embodied on a computer readable medium for controlling access to a modular storage unit having one or more lockable compartments, at least one locking/unlocking apparatus and a unit controller, the computer program comprising a code segment for determining whether or not to send a message to the unit controller wherein the message comprises an instruction to lock or unlock one or more of the lockable compartments or information that can be used to determine whether to lock or unlock one or more of the lockable compartments.
